(19) United States
(12) Patent Application Publication
(10) Pub. No.: US 2026/0143477 A1
(43) Pub. Date: May 21, 2026

(54) COMMUNICATION METHOD AND APPARATUS

(71) Applicant: HUAWEI TECHNOLOGIES CO., LTD., Shenzhen (CN)

(72) Inventors: Kexin Li, Shenzhen (CN); Chuili Kong, Hangzhou (CN); Hejia Luo, Ottawa (CA); Ruonan Yang, Shenzhen (CN); Rong Li, Boulogne Billancourt (FR); Jun Wang, Hangzhou (CN)

(21) Appl. No.: 19/451,001

(22) Filed: Jan. 16, 2026

Related U.S. Application Data
(63) Continuation of application No. PCT/CN2024/099965, filed on Jun. 18, 2024.

(30) Foreign Application Priority Data
Jul. 18, 2023 (CN) 202310888047.5

(51) Int. Cl. H04W 72/0446

(52) U.S. Cl. CPC H04W 72/0446

(57) ABSTRACT

Embodiments of this application belong to the field of communication technologies. In the method, a second network device may send, to a terminal device, a message including at least one non-consecutive time domain resource configuration. A time domain resource indicated by the at least one time domain resource configuration does not include an unavailable downlink time domain resource that is of the second network device and that is reported by the terminal device to a first network device. Therefore, the network device does not need to reconfigure each parameter in a rate matching field each time to indicate an unavailable downlink time domain resource segment. This can shorten time for reconfiguring the rate matching field, and therefore reduce a redundant configuration of communication signaling and improve communication efficiency, to implement flexible time domain resource assignment.

### CROSS-REFERENCE TO RELATED APPLICATIONS

This application is a continuation of International Application No. PCT/CN2024/099965, filed on Jun. 18, 2024, which claims priority to Chinese Patent Application No. 202310888047.5, filed on Jul. 18, 2023. The disclosures of the aforementioned applications are hereby incorporated by reference in their entireties.

### TECHNICAL FIELD

This application relates to the communication field, and in particular, to a communication method and apparatus.

### BACKGROUND

There is a latency difference between network devices. The latency difference causes the network device to assign a non-consecutive time domain resource to a downlink channel, for example, a physical downlink shared channel (physical downlink shared channel, PDSCH). Currently, the network device may indicate a consecutive time domain resource by using time domain resource assignment (time domain resource assignment, TDRA) information, and indicate, by using a rate matching (rateMatched) field, a downlink time domain resource segment unavailable to the PDSCH.

However, as a location of the network device keeps changing, the network device needs to reconfigure a parameter in the rate matching field at regular intervals. This causes a redundant configuration of communication signaling, resulting in communication efficiency decline.

### SUMMARY

Embodiments of this application provide a communication method and apparatus, to reduce a redundant configuration of communication signaling and improve communication efficiency.

To achieve the foregoing objective, the following technical solutions are used in this application.

According to a first aspect, a communication method is provided. The method includes: A terminal device sends first indication information to a first network device, and receives a first message from a second network device. The first indication information is used for indicating an unavailable downlink time domain resource, and the unavailable downlink time domain resource is an unavailable downlink time domain resource of the second network device. The first message includes at least one downlink time domain resource configuration, a time domain resource indicated by the at least one downlink time domain resource configuration is a time domain resource available to downlink communication between the second network device and the terminal device, the time domain resource indicated by the at least one downlink time domain resource configuration is a non-consecutive time domain resource, and the time domain resource indicated by the at least one time domain resource configuration does not include the unavailable downlink time domain resource.

It can be learned from the method according to the first aspect that the second network device may send, to the terminal device, a message including at least one non-consecutive time domain resource configuration. A time domain resource indicated by the at least one time domain resource configuration does not include the unavailable downlink time domain resource that is of the second network device and that is reported by the terminal device to the first network device. Therefore, the network device does not need to reconfigure each parameter in a rate matching field each time to indicate an unavailable downlink time domain resource segment. This can shorten time for reconfiguring the rate matching field, and therefore reduce a redundant configuration of communication signaling and improve communication efficiency, to implement flexible time domain resource assignment.

In a possible design solution, the method according to the first aspect may further include: The terminal device sends second indication information to the first network device. The second indication information indicates that a network device to which the unavailable downlink time domain resource belongs is the second network device, and the second indication information includes an identity of the second network device. In this way, the first network device may accurately determine, based on the identity of the second network device, that the unavailable downlink time domain resource is the unavailable downlink time domain resource of the second network device, to avoid incorrect identification or misidentification.

In a possible design solution, after the terminal device receives the first message from the second network device, the method according to the first aspect may further include: The terminal device receives configuration information from the second network device, and performs downlink communication with the second network device on a time domain resource indicated by a first time domain resource configuration. The configuration information indicates the terminal device to perform downlink communication with the second network device on the time domain resource indicated by the first time domain resource configuration. In this way, the terminal device can avoid performing downlink communication with the second network device on the unavailable downlink time domain resource, to mitigate interference caused to the first network device.

Optionally, after the terminal device receives the first message from the second network device, the method in the first aspect further includes: When downlink communication between the terminal device and the first network device does not meet a preset condition, the terminal device sends third indication information to the first network device. The third indication information indicates that downlink communication between the terminal device and the first network device does not meet the preset condition. It may be understood that, when the first network device is not interfered by another network device like the second network device, or when the first network device is less interfered by another network device like the second network device, the terminal device may report to the first network device that downlink communication of the first network device is not interfered by the second network device, so that the second network device can subsequently restore communication on a previously unavailable downlink time domain resource. For example, the terminal device receives a second message from the second network device, and performs downlink communication with the second network device on a consecutive time domain resource that is configured for downlink communication and that is indicated by the second message. This can reduce a waste of resources and improve resource utilization.

Optionally, that the terminal device sends the first indication information to the first network device includes: When downlink communication between the terminal device and the first network device meets a preset condition, the terminal device sends the first indication information to the first network device. The preset condition includes at least one of the following: a block error rate is greater than a first preset threshold, a signal to interference plus noise ratio is greater than a second preset threshold, or a communication rate is less than a third preset threshold. In other words, only when downlink communication of the first network device is interfered by the second network device, the terminal device sends the unavailable downlink time domain resource of the second network device to the first network device, so that the second network device may be subsequently triggered to assign at least one downlink time domain resource configuration to the downlink communication, to implement flexible downlink time domain resource configuration, thereby avoiding interference.

Optionally, after the terminal device sends the third indication information to the first network device, the method in the first aspect further includes:

The terminal device receives the second message from the second network device, and performs, based on the second message, downlink communication with the second network device on a consecutive time domain resource configured for downlink communication. The second message indicates a consecutive time domain resource configured for downlink communication of the second network device. In this way, the second network device can restore communication on the previously unavailable downlink time domain resource. This can reduce a waste of resources and improve resource utilization.

In a possible design solution, the first message carries information indicating a consecutive time domain resource, and the information indicating a consecutive time domain resource further indicates the at least one downlink time domain resource configuration. It may be understood that the at least one non-consecutive time domain resource configuration may be directly indicated by using the existing information indicating a consecutive time domain resource, to reduce implementation difficulty. Alternatively, the at least one non-consecutive time domain resource configuration is jointly indicated by using the existing information indicating a consecutive time domain resource and other information, to improve implementation flexibility. This is not limited.

In a possible design solution, the first time domain resource configuration is one of the at least one time domain resource configuration, the first time domain resource configuration includes a bitmap, and the bitmap is used to represent the time domain resource indicated by the first time domain resource configuration. Different bits in the bitmap may respectively correspond to different time units, and a value of each bit may indicate whether a time unit corresponding to the bit is an available time unit of the second network device. In this way, the terminal device can intuitively determine a non-consecutive time domain resource based on different values of a plurality of bits.

In a possible design solution, the first time domain resource configuration includes first information and second information; the first information indicates a time domain resource configured for downlink communication between the terminal device and the second network device, and the second information indicates the unavailable downlink time domain resource; and the configured time domain resource includes the unavailable downlink time domain resource. It may be understood that, because a time domain resource range that can be represented by the bitmap is limited by a quantity of bits, compared with the foregoing manner of directly representing, by using the bitmap, the time domain resource indicated by the first time domain resource configuration, a manner of indicating the first time domain resource configuration by using the first information and the second information is more flexible.

Optionally, the first information is start symbol and symbol length information of the configured time domain resource, or any other possible information; and the second information is start symbol and symbol length information of the unavailable time domain resource, or any other possible information. Both the first information and the second information are carried in the existing information indicating a consecutive time domain resource, to reduce implementation difficulty.

Optionally, the second information is an information element in a medium access control-control element MAC-CE. In this case, the first information and the second information are respectively carried in different information, so that implementation flexibility can be improved.

In a possible design solution, the first time domain resource configuration is one of the at least one time domain resource configuration, the first time domain resource configuration includes first information and second information, the first information indicates a first time domain resource, and the second information indicates a second time domain resource; and the first time domain resource includes at least one consecutive time domain resource segment in a time domain resource indicated by the first time domain resource configuration, and the second time domain resource includes a time domain resource other than the at least one consecutive time domain resource segment in the time domain resource indicated by the first time domain resource configuration. In this way, the terminal device may directly determine, based on consecutive time domain resources respectively indicated by the first information and the second information, the time domain resource indicated by the first time domain resource configuration. Because a time domain resource range that can be represented by the bitmap is limited by a quantity of bits, compared with the foregoing manner of directly representing, by using the bitmap, the time domain resource indicated by the first time domain resource configuration, a manner of indicating the first time domain resource configuration by using the first information and the second information is more flexible.

Optionally, the first information is start symbol and symbol length information of the first time domain resource, or any other possible information; and the second information is start symbol and symbol length information of the second time domain resource, or any other possible information. Both the first information and the second information are carried in the existing information indicating a consecutive time domain resource, to reduce implementation difficulty. Optionally, the second information is an information element in a medium access control-control element MAC-CE. In this case, the first information and the second information are respectively carried in different information, so that implementation flexibility can be improved.

In a possible design solution, the time domain resource indicated by the first time domain resource configuration includes at least two consecutive time domain resource segments. In this way, the time domain resource indicated by the first time domain resource configuration can meet time domain resource requirements of the second network device in different scenarios.

In a possible design solution, a cell of the first network device and a cell of the second network device are neighboring cells. In other words, both the first network device and the second network device may provide a service for the terminal device.

Optionally, the first message is carried in at least one of the following: a radio resource control RRC message, a downlink control information DCI, a MAC-CE, or a system information block SIB1. In other words, the first message is carried in an existing information element, to reduce implementation difficulty, or may be carried in a new information element, to improve implementation flexibility. This is not limited.

According to a second aspect, a communication method is provided. The method includes: A second network device receives first indication information from a first network device, and sends a first message to a terminal device. The first indication information indicates an unavailable downlink time domain resource, and the unavailable downlink time domain resource is an unavailable downlink time domain resource of the second network device. The first message includes at least one downlink time domain resource configuration, a time domain resource indicated by the at least one downlink time domain resource configuration is a time domain resource available to downlink communication between the second network device and the terminal device, the time domain resource indicated by the at least one downlink time domain resource configuration is a non-consecutive time domain resource, and the time domain resource indicated by the at least one time domain resource configuration does not include the unavailable downlink time domain resource.

In a possible design solution, the first message carries information indicating a consecutive time domain resource, and the information indicating a consecutive time domain resource further indicates the at least one downlink time domain resource configuration.

In a possible design solution, a first time domain resource configuration is one of the at least one time domain resource configuration, the first time domain resource configuration includes a bitmap, and the bitmap is used to represent a time domain resource indicated by the first time domain resource configuration.

In a possible design solution, a first time domain resource configuration includes first information and second information; the first information indicates a time domain resource configured for downlink communication between the terminal device and the second network device, and the second information indicates the unavailable downlink time domain resource; and the configured time domain resource includes the unavailable downlink time domain resource.

Optionally, the first information is start symbol and symbol length information of the configured time domain resource, and the second information is start symbol and symbol length information of the unavailable time domain resource.

Optionally, the second information is an information element in a medium access control-control element MAC-CE.

In a possible design solution, a first time domain resource configuration is one of the at least one time domain resource configuration, the first time domain resource configuration includes first information and second information, the first information indicates a first time domain resource, and the second information indicates a second time domain resource; and the first time domain resource includes at least one consecutive time domain resource segment in a time domain resource indicated by the first time domain resource configuration, and the second time domain resource includes a time domain resource other than the at least one consecutive time domain resource segment in the time domain resource indicated by the first time domain resource configuration.

Optionally, the first information is start symbol and symbol length information of the first time domain resource, and the second information is start symbol and symbol length information of the second time domain resource.

Optionally, the second information is an information element in a medium access control-control element MAC-CE.

In a possible design solution, the time domain resource indicated by the first time domain resource configuration includes at least two consecutive time domain resource segments.

In a possible design solution, a cell of the first network device and a cell of the second network device are neighboring cells.

Optionally, the first message is carried in at least one of the following: a radio resource control RRC message, a downlink control information DCI, a MAC-CE, or a system information block SIB1.

In addition, for other technical effects of the method according to the second aspect, refer to the technical effects of the method according to the first aspect. Details are not described herein again.

According to a third aspect, a communication apparatus is provided. The apparatus includes modules configured to perform the method according to the first aspect, for example, a transceiver module and a processing module.

The processing module is configured to control the transceiver module to send first indication information to a first network device. The transceiver module is configured to receive a first message from a second network device. The first indication information indicates an unavailable downlink time domain resource, and the unavailable downlink time domain resource is an unavailable downlink time domain resource of the second network device. The first message includes at least one downlink time domain resource configuration, a time domain resource indicated by the at least one downlink time domain resource configuration is a time domain resource available to downlink communication between the second network device and the communication apparatus according to the third aspect, the time domain resource indicated by the at least one downlink time domain resource configuration is a non-consecutive time domain resource, and the time domain resource indicated by the at least one time domain resource configuration does not include the unavailable downlink time domain resource.

In a possible design solution, the processing module is further configured to control the transceiver module to send second indication information to the first network device. The second indication information indicates that a network device to which the unavailable downlink time domain resource belongs is the second network device, and the second indication information may include an identity of the second network device.

In a possible design solution, after the communication apparatus according to the third aspect receives the first message from the second network device, the transceiver module is further configured to receive configuration information from the second network device. The processing module is further configured to perform downlink communication with the second network device on a time domain resource indicated by a first time domain resource configuration. The configuration information indicates the communication apparatus to perform downlink communication with the second network device on the time domain resource indicated by the first time domain resource configuration.

Optionally, when downlink communication between the communication apparatus according to the third aspect and the first network device meets a preset condition, the processing module is further configured to control the transceiver module to send the first indication information to the first network device. The preset condition includes at least one of the following: a block error rate is greater than a first preset threshold, a signal to interference plus noise ratio is greater than a second preset threshold, or a communication rate is less than a third preset threshold.

Optionally, after the communication apparatus according to the third aspect receives the first message from the second network device, when downlink communication between the communication apparatus and the first network device does not meet a preset condition, the processing module is further configured to control the transceiver module to send third indication information to the first network device. The third indication information indicates that downlink communication between the communication apparatus and the first network device does not meet the preset condition.

Optionally, after the communication apparatus according to the third aspect sends the third indication information to the first network device, the transceiver module is further configured to receive a second message from the second network device. The processing module is further configured to perform, based on the second message, downlink communication with the second network device on a consecutive time domain resource configured for downlink communication. The second message indicates a consecutive time domain resource configured for downlink communication of the second network device.

In a possible design solution, the first message carries information indicating a consecutive time domain resource, and the information indicating a consecutive time domain resource further indicates the at least one downlink time domain resource configuration.

In a possible design solution, the first time domain resource configuration is one of the at least one time domain resource configuration, the first time domain resource configuration includes a bitmap, and the bitmap is used to represent the time domain resource indicated by the first time domain resource configuration.

In a possible design solution, the first time domain resource configuration includes first information and second information; the first information indicates a time domain resource configured for downlink communication between the communication apparatus according to the third aspect and the second network device, and the second information indicates the unavailable downlink time domain resource; and the configured time domain resource includes the unavailable downlink time domain resource.

Optionally, the first information is start symbol and symbol length information of the configured time domain resource, and the second information is start symbol and symbol length information of the unavailable time domain resource.

Optionally, the second information is an information element in a medium access control-control element MAC-CE.

In a possible design solution, the first time domain resource configuration is one of the at least one time domain resource configuration, the first time domain resource configuration includes first information and second information, the first information indicates a first time domain resource, and the second information indicates a second time domain resource; and the first time domain resource includes at least one consecutive time domain resource segment in a time domain resource indicated by the first time domain resource configuration, and the second time domain resource includes a time domain resource other than the at least one consecutive time domain resource segment in the time domain resource indicated by the first time domain resource configuration.

Optionally, the first information is start symbol and symbol length information of the first time domain resource, and the second information is start symbol and symbol length information of the second time domain resource.

Optionally, the second information is an information element in a medium access control-control element MAC-CE.

In a possible design solution, the time domain resource indicated by the first time domain resource configuration includes at least two consecutive time domain resource segments.

Optionally, the transceiver module may include a sending module and a receiving module. The sending module is configured to implement a sending function of the communication apparatus according to the third aspect, and the receiving module is configured to implement a receiving function of the communication apparatus according to the third aspect.

Optionally, the communication apparatus according to the third aspect may further include a storage module. The storage module stores a program or instructions. When the processing module executes the program or the instructions, the communication apparatus is caused to perform the communication method according to the first aspect.

It should be noted that the communication apparatus according to the third aspect may be a terminal device, may be a chip (system) or another part or component in the terminal device, or may be an apparatus including the terminal device. This is not limited in this application.

In addition, for technical effects of the communication apparatus according to the third aspect, refer to technical effects of the communication method according to the first aspect. Details are not described herein again.

According to a fourth aspect, a communication apparatus is provided. The communication apparatus includes modules configured to perform the method according to the second aspect, for example, a transceiver module and a processing module.

The transceiver module is configured to receive first indication information from a first network device. The processing module is further configured to control, based on the first indication information, the transceiver module to send a first message to a terminal device. The first indication information indicates an unavailable downlink time domain resource, and the unavailable downlink time domain resource is an unavailable downlink time domain resource of the communication apparatus. The first message includes at least one downlink time domain resource configuration, a time domain resource indicated by the at least one downlink time domain resource configuration is a time domain resource available to downlink communication between the communication apparatus and the terminal device, the time domain resource indicated by the at least one downlink time domain resource configuration is a non-consecutive time domain resource, and the time domain resource indicated by the at least one time domain resource configuration does not include the unavailable downlink time domain resource.

In a possible design solution, the first message carries information indicating a consecutive time domain resource, and the information indicating a consecutive time domain resource further indicates the at least one downlink time domain resource configuration.

In a possible design solution, a first time domain resource configuration is one of the at least one time domain resource configuration, the first time domain resource configuration includes a bitmap, and the bitmap is used to represent a time domain resource indicated by the first time domain resource configuration.

In a possible design solution, a first time domain resource configuration includes first information and second information; the first information indicates a time domain resource configured for downlink communication between the terminal device and the communication apparatus according to the fourth aspect, and the second information indicates the unavailable downlink time domain resource; and the configured time domain resource includes the unavailable downlink time domain resource.

Optionally, the first information is start symbol and symbol length information of the configured time domain resource, and the second information is start symbol and symbol length information of the unavailable time domain resource.

Optionally, the second information is an information element in a medium access control-control element MAC-CE.

In a possible design solution, a first time domain resource configuration is one of the at least one time domain resource configuration, the first time domain resource configuration includes first information and second information, the first information indicates a first time domain resource, and the second information indicates a second time domain resource; and the first time domain resource includes at least one consecutive time domain resource segment in a time domain resource indicated by the first time domain resource configuration, and the second time domain resource includes a time domain resource other than the at least one consecutive time domain resource segment in the time domain resource indicated by the first time domain resource configuration.

Optionally, the first information is start symbol and symbol length information of the first time domain resource, and the second information is start symbol and symbol length information of the second time domain resource.

Optionally, the second information is an information element in a medium access control-control element MAC-CE.

In a possible design solution, the time domain resource indicated by the first time domain resource configuration includes at least two consecutive time domain resource segments.

In a possible design solution, a cell of the first network device and a cell of the communication apparatus according to the fourth aspect are neighboring cells.

Optionally, the first message is carried in at least one of the following: a radio resource control RRC message, a downlink control information DCI, a MAC-CE, or a system information block SIB1.

Optionally, the transceiver module may include a sending module and a receiving module. The sending module is configured to implement a sending function of the communication apparatus according to the fourth aspect, and the receiving module is configured to implement a receiving function of the communication apparatus according to the fourth aspect.

Optionally, the transceiver module may include a sending module and a receiving module. The sending module is configured to implement a sending function of the communication apparatus according to the fourth aspect, and the receiving module is configured to implement a receiving function of the communication apparatus according to the fourth aspect.

Optionally, the communication apparatus according to the fourth aspect may further include a storage module. The storage module stores a program or instructions. When the processing module executes the program or the instructions, the communication apparatus is caused to perform the method according to the second aspect.

It may be understood that the communication apparatus according to the fourth aspect may be a network device, may be a chip (system) or another part or component in the network device, or may be an apparatus including the network device. This is not limited in this application.

In addition, for technical effects of the communication apparatus according to the fourth aspect, refer to the technical effects of the method according to the second aspect. Details are not described herein again.

According to a fifth aspect, a communication apparatus is provided. The communication apparatus includes a processor. The processor is configured to perform the communication method according to the first aspect or the second aspect.

In a possible design solution, the communication apparatus according to the fifth aspect may further include a transceiver. The transceiver may be a transceiver circuit or an interface circuit. The transceiver may be used by the communication apparatus according to the fifth aspect to communicate with another communication apparatus.

In a possible design solution, the communication apparatus according to the fifth aspect may further include a memory. The memory and the processor may be integrated together, or may be disposed separately. The memory may be configured to store a computer program and/or data related to the communication method according to the first aspect or the second aspect.

In embodiments of this application, the communication apparatus according to the fifth aspect may be the network device according to any one of the first aspect or the second aspect, a chip (system) or another part or component in the network device, or an apparatus including the network device. Alternatively, the communication apparatus may be the terminal device according to any one of the first aspect or the second aspect, a chip (system) or another part or component in the terminal device, or an apparatus including the terminal device.

In addition, for technical effects of the communication apparatus according to the fifth aspect, refer to technical effects of the communication method according to the first aspect or the second aspect. Details are not described herein again.

According to a sixth aspect, a communication apparatus is provided. The communication apparatus includes a processor. The processor is coupled to a memory, and the processor is configured to execute a computer program stored in the memory, to cause the communication apparatus to perform the communication method according to the first aspect or the second aspect.

In a possible design solution, the communication apparatus according to the sixth aspect may further include a transceiver. The transceiver may be a transceiver circuit or an interface circuit. The transceiver may be used by the communication apparatus according to the sixth aspect to communicate with another communication apparatus.

In embodiments of this application, the communication apparatus according to the sixth aspect may be the network device according to any one of the first aspect or the second aspect, a chip (system) or another part or component in the network device, or an apparatus including the network device. Alternatively, the communication apparatus may be the terminal device according to any one of the first aspect or the second aspect, a chip (system) or another part or component in the terminal device, or an apparatus including the terminal device.

In addition, for technical effects of the communication apparatus according to the sixth aspect, refer to technical effects of the communication method according to the first aspect or the second aspect. Details are not described herein again.

According to a seventh aspect, a communication apparatus is provided, and includes a processor and a memory. The memory is configured to store a computer program. When the processor executes the computer program, the communication apparatus is caused to perform the communication method according to the first aspect or the second aspect.

In a possible design solution, the communication apparatus according to the seventh aspect may further include a transceiver. The transceiver may be a transceiver circuit or an interface circuit. The transceiver may be used by the communication apparatus according to the seventh aspect to communicate with another communication apparatus.

In embodiments of this application, the communication apparatus according to the seventh aspect may be the network device according to any one of the first aspect or the second aspect, a chip (system) or another part or component in the network device, or an apparatus including the network device. Alternatively, the communication apparatus may be the terminal device according to any one of the first aspect or the second aspect, a chip (system) or another part or component in the terminal device, or an apparatus including the terminal device.

In addition, for technical effects of the communication apparatus according to the seventh aspect, refer to technical effects of the communication method according to the first aspect or the second aspect. Details are not described herein again.

According to an eighth aspect, a communication apparatus is provided, and includes a processor. The processor is configured to: after being coupled to a memory and reading a computer program in the memory, perform the communication method according to the first aspect or the second aspect based on the computer program.

In a possible design solution, the communication apparatus according to the eighth aspect may further include a transceiver. The transceiver may be a transceiver circuit or an interface circuit. The transceiver may be used by the communication apparatus according to the eighth aspect to communicate with another communication apparatus.

In embodiments of this application, the communication apparatus according to the eighth aspect may be the network device according to any one of the first aspect or the second aspect, a chip (system) or another part or component in the network device, or an apparatus including the network device. Alternatively, the communication apparatus may be the terminal device according to any one of the first aspect or the second aspect, a chip (system) or another part or component in the terminal device, or an apparatus including the terminal device.

In addition, for technical effects of the communication apparatus according to the eighth aspect, refer to technical effects of the communication method according to the first aspect or the second aspect. Details are not described herein again.

According to a ninth aspect, a communication system is provided. The communication system includes the terminal device, the first network device, and the second network device according to the first aspect to the fourth aspect.

According to a tenth aspect, a computer-readable storage medium is provided, including a computer program or instructions. When the computer program or the instructions are run on a computer, the computer is caused to perform the communication method according to the first aspect or the second aspect.

According to an eleventh aspect, a computer program product is provided, including a computer program or instructions. When the computer program or the instructions are run on a computer, the computer is caused to perform the communication method according to the first aspect or the second aspect.

According to a twelfth aspect, a communication method is provided. The method includes: A terminal device sends first indication information to a first network device; and a second network device receives the first indication information from the first network device, and sends a first message to the terminal device based on the first indication information. The first indication information indicates an unavailable downlink time domain resource, and the unavailable downlink time domain resource is an unavailable downlink time domain resource of the second network device. The first message includes at least one downlink time domain resource configuration, a time domain resource indicated by the at least one downlink time domain resource configuration is a time domain resource available to downlink communication between the second network device and the terminal device, the time domain resource indicated by the at least one downlink time domain resource configuration is a non-consecutive time domain resource, and the time domain resource indicated by the at least one time domain resource configuration does not include the unavailable downlink time domain resource.

It may be understood that, for other technical effects of the method according to the twelfth aspect, refer to the technical effects of the method according to the first aspect or the second aspect. Details are not described herein again.

### BRIEF DESCRIPTION OF DRAWINGS

FIG. 1 is a diagram of DMRS time-frequency resource occupation of a base station 1 and a base station 2;

FIG. 2 is a diagram of DMRS time-frequency resource occupation of a satellite 1 and a satellite 2;

FIG. 3 is a diagram of a time domain resource reserved by a satellite 2;

FIG. 4 is a diagram of a non-consecutive time domain resource occupied by a PDSCH of a satellite 2;

FIG. 5 is a first diagram of an architecture of a communication system according to an embodiment of this application;

FIG. 6 is a second diagram of an architecture of a communication system according to an embodiment of this application;

FIG. 7 is a third diagram of an architecture of a communication system according to an embodiment of this application;

FIG. 8 is a schematic flowchart of a communication method according to an embodiment of this application;

FIG. 9 is a first diagram of a structure of an unavailable downlink time domain resource configured by using a MAC-CE according to an embodiment of this application;

FIG. 10 is a second diagram of a structure of an unavailable downlink time domain resource configured by using a MAC-CE according to an embodiment of this application;

FIG. 11 is a first diagram of a structure of an additional downlink time domain resource configured by using a MAC-CE according to an embodiment of this application;

FIG. 12 is a second diagram of a structure of an additional downlink time domain resource configured by using a MAC-CE according to an embodiment of this application;

FIG. 13 is a first diagram of a structure of a communication apparatus according to an embodiment of this application; and

FIG. 14 is a second diagram of a structure of a communication apparatus according to an embodiment of this application.

### DESCRIPTION OF EMBODIMENTS

For ease of understanding, technical terms in embodiments of this application are described first below.

### 1. Non-Terrestrial Network (Non-Terrestrial Network, NTN)

With the development of the society and the advancement of technologies, various applications of mobile communication emerge continuously, imposing higher requirements on a communication system. A future communication system not only needs to support a higher communication rate, but also needs to meet requirements such as lower latency, higher reliability, and a larger quantity of connected devices. In addition, because a terrestrial cellular system has high deployment costs and a limited coverage capability, construction of the NTN has been proposed in a 5th generation (5G) mobile communication system, to implement truly seamless global coverage.

The NTN refers to a terminal-and-satellite direct communication technology that is based on a new radio technology. The NTN already has a basic satellite communication capability for an enhanced air interface protocol is designed and advanced technologies such as scheduling time sequence management, uplink transmission latency compensation, and fast air-to-ground handover are introduced for the NTN. A satellite is an important part of the NTN, with advantages of large coverage and immunity to natural disasters. In recent years, low earth orbit (low earth orbit, LEO) satellites, located 200 km to 2000 km from the ground, have attracted attention of people again. Compared with satellites in higher orbits, the LEO satellites, as one of key infrastructures for global network coverage, have low communication latency, low path losses, and low manufacturing costs.

### 2. Time Domain Resource

In a new radio (new radio, NR) system, uplink transmission may be formed into a plurality of radio frames (frame). Duration of each radio frame is 10 ms. Each radio frame may include 10 subframes whose duration is 1 ms. 10 subframes in one radio frame may be arranged in sequence. For example, the 10 subframes in the radio frame may be sorted in a sequence of a subframe #0 to a subframe #9. It may be understood that numbers and a sequence of the subframe #0 to the subframe #9 are merely examples. For example, a start number may alternatively be #1, and a radio frame includes a subframe #1 to a subframe #10. For another example, the 10 subframes may be sorted in descending order, and the radio frame includes a subframe #9 to a subframe #0. This is not specifically limited in embodiments of this application.

In the NR system, one subframe may include several slots (slot). For a subcarrier spacing configuration μ, the slots in the subframe may be arranged in ascending order of numbers

$${n}_{s}^{μ} ∈ \{ 0 , … , {N}_{slot}^{subframe , μ} - 1 \} ,$$

and the slots in the radio frame may be arranged in ascending order of numbers

$${n}_{s , f}^{μ} ∈ \{ 0 , … , {N}_{slot}^{frame , μ} - 1 \} .$$

### There are

$${N}_{symb}^{slot}$$

consecutive orthogonal frequency division multiplexing (orthogonal frequency division multiplexing, OFDM) symbols (symbol) in one slot, as shown in Table 1 and Table 2. A start of a slot

$${n}_{s}^{μ}$$

in a subframe is aligned in time with a start of an OFDM symbol

$${n}_{s}^{μ} {N}_{symb}^{slot}$$

in the same subframe. For example, when one slot includes 14 OFDM symbols, the OFDM symbols may be sorted in chronological order as an OFDM symbol #0 to an OFDM symbol #13.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 2

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

### 3. Frequency Domain Resource

In an NR system, the frequency domain resource may be classified into a resource element (resource element, RE), a resource block (resource block, RB), and a bandwidth part (bandwidth part, BWP) based on a size of the frequency domain resource, which are separately described below.

### (1) Re

In the NR system, one subcarrier in frequency domain or one OFDM symbol in time domain may be defined as an RE. The RE is a resource at a minimum granularity at a physical layer. The RE may also be understood as a time-frequency resource, that is, the RE includes a time domain resource and a frequency domain resource.

### (2) RB

In frequency domain, regardless of a subcarrier spacing, 12 consecutive subcarriers may be defined as one RB in the NR system. At the physical layer, the RB may be referred to as a physical resource block (physical resource block, PRB).

### (3) BWP

The NR system can support a terminal device in operating in only a part of a system bandwidth, that is, a BWP. Alternatively, the BWP may be a plurality of RBs in a frequency domain resource corresponding to one carrier supported by one cell. For example, a cell covered by a network device (for example, a next-generation radio access network (next-generation radio access network, NG-RAN) device in the NR system) can support two carrier frequencies (referred to as a carrier #1 and a carrier #2 for short below). A bandwidth of 40 MHz is assigned to the carrier #1 and a bandwidth of 60 MHz is assigned to the carrier #2 in the cell. The BWP may be a bandwidth of 20 MHz in the bandwidth of 40 MHz corresponding to the carrier #1. The bandwidth of 20 MHz includes a plurality of RBs. The terminal device may operate in only the BWP.

It may be understood that, in embodiments of this application, meanings of “carrier frequency”, “carrier”, “carrier frequency”, and “frequency” are the same. In other words, “carrier frequency”, “carrier”, “carrier frequency”, and “frequency” may be interchanged for description. This is uniformly described herein, and details are not described below again. It should be further understood that, in embodiments of this application, meanings of “number” and “index” are the same. In other words, “number” and “index” may be interchanged for description. This is uniformly described herein, and details are not described below again.

### 4. PDSCH Time-Frequency Resource Assignment Mode

In an NR system, a network device may assign a PDSCH time-frequency resource by sending a radio resource control (radio resource control, RRC) message and a downlink control information (downlink control Information, DCI) to a terminal device.

A start symbol and a quantity of continuous symbols of a PDSCH time domain resource may be determined based on TDRA in the DCI, and the start symbol and the quantity of continuous symbols may be determined based on a start and length indicator value (start and length indicator value, SLIV).

For the TDRA, time domain resource assignment modes of type (type) A and type B can be supported. type A refers to slot-based scheduling. A value of the start symbol may be a symbol #0 to a symbol #3 in a current slot, and a value of a symbol length may be 3 to 14. The value of the symbol length in type A is large. type A is applicable to an enhanced mobile broadband (enhanced mobile broadband, eMBB) scenario.

type B refers to mini-slot (mini-slot)-based scheduling. A value of the start symbol may be a symbol #0 to a symbol #12 in a current slot, and a value of a symbol length may be 2 to 13. In type B, a location of the start symbol is more flexible, latency is lower. type B is applicable to an ultra-reliable low latency communications (ultra-reliable low latency communications, URLLC) scenario.

A PDSCH frequency domain resource may be determined based on frequency domain resource assignment (frequency domain resource assignment, FDRA) in the DCI, and for the FDRA, frequency domain resource assignment modes of type 0 and type 1 can be supported. A minimum resource assignment granularity in type 0 is a resource block group (resource block group, RBG), each RBG includes a plurality of RBs, and a frequency domain resource assigned by the network device to the terminal in type 0 may be consecutive or non-consecutive. For example, the network device may indicate RB assignment by using a bitmap (bitmap) of an RBG. Each bit (bit) in the bitmap may represent one RBG. The bitmap may be carried in a resource assignment field in the downlink control information. The network device may send the DCI message to the terminal, to send information about the bitmap to the terminal device.

A minimum resource assignment granularity in type 1 is a resource block RB, and a frequency domain resource assigned by the network device to the terminal device in type 1 is usually consecutive. RB resource assignment may be indicated by using a resource indication value (resource indication value, RIV), to be specific, a start RB location and a quantity of RBs are indicated by using the RIV. The RIV may be carried in the resource assignment field in the DCI. The network device may send information about the RIV to the terminal device by using the DCI.

The following uses the following two cases as an example to describe in detail a process of assigning a PDSCH time domain resource by the network device.

Case 1: The network device assigns a consecutive time domain resource to the PDSCH.

(1) The network device sends a PDSCH configuration list (pdsch-AllocationList) to the terminal device by using an RRC message.

pdsch-AllocationList may be understood as a list including a plurality of time domain resource configurations. For example, pdsch-AllocationList may be a list including 16 rows. The rows of the list represent different time domain resource configurations. A time domain resource configuration corresponding to each row is determined based on parameters in PDSCH time domain resource configuration (PDSCH-TimeDomainResourceAllocation) information. To be specific, PDSCH-AllocationList includes 16 pieces of PDSCH-TimeDomainResourceAllocation information, and each piece of PDSCH-TimeDomainResourceAllocation information may include the following parameters: k0, mapping type (mappingType), and start symbol and symbol length (startSymbolAndLength).

k0 may indicate a quantity of offset slots between the PDSCH and a physical downlink control channel (physical downlink control channel, PDCCH). mappingType may indicate that the frequency domain resource assignment mode is type A or type B. startSymbolAndLength (that is, the SLIV) may indicate a start symbol and a symbol length of the PDSCH.

It may be understood that pdsch-AllocationList used to assign a consecutive time domain resource may be denoted as pdsch-AllocationList #1, and PDSCH time domain resource configuration information in pdsch-AllocationList #1 is denoted as PDSCH-TimeDomainResourceAllocation #11, PDSCH-TimeDomainResourceAllocation #12, . . . , and PDSCH-TimeDomainResourceAllocation #1n. A value of n is any integer greater than or equal to 1. A quantity of pieces of PDSCH-TimeDomainResourceAllocation information included in pdsch-AllocationList is not limited in embodiments of this application.

For example, pdsch-AllocationList #1 may be in the following format:

```
pdsch-AllocationList#1{
  PDSCH-TimeDomainResourceAllocation#11{
    k0
    mappingType
    startSymbolAndLength
  }
  PDSCH-TimeDomainResourceAllocation#12{
    k0
    mappingType
    startSymbolAndLength
  }
  ...
}
```

### (2) the Network Device Sends the DCI to the Terminal Device.

The TDRA in the DCI may indicate which time domain resource configuration that is in the plurality of time domain resource configurations and that the terminal device selects. In other words, the TDRA may indicate which time domain resource configuration that is in pdsch-AllocationList and that indicates a time domain resource on which the terminal device receives a downlink signal from the network device. For example, the TDRA may include four bits (bit). The four bits may have 16 different values, and each of the 16 different values corresponds to one of the foregoing 16 time domain resource configurations. The terminal device may determine the time domain resource configuration of the PDSCH based on the values of the four bits.

### Case 2: The Network Device May Assign an Unavailable Downlink Time Domain Resource to the PDSCH.

When the network device needs to notify the terminal device of a time-frequency resource occupied by some signals or channels, or when the network device needs to notify the terminal device of an unavailable time-frequency resource, the network device may indicate a location of the unavailable time-frequency resource by configuring rate matching information in an RRC message. For example, the network device may indicate the location of the unavailable time-frequency resource by configuring a rate matching pattern of a rate matching pattern for a long term evolution (long time evolution, LTE) cell reference signal (cell reference signal, CRS) (rateMatchPatternLTE-CRS) field or a rate matching pattern (rateMatchPattern) field in the RRC message. The rateMatchPatternLTE-CRS field is dedicated to indicating an unavailable time-frequency resource of an LTE CRS signal, and the rateMatchPattern field may indicate any unavailable time-frequency resource.

The rateMatchPattern field may include a resource blocks (resourceBlocks) bitmap, a symbols in resource block (symbolsInResourceBlock) bitmap, and a periodicity and pattern (periodicityAndPattern) bitmap. The resource blocks bitmap may indicate specific RBs in which an unavailable time-frequency resource exists, and may occupy 275 bits. The symbols in resource block bitmap may indicate specific symbols in which an unavailable time-frequency resource exists, and may occupy 14 bits or 28 bits. The periodicity and pattern bitmap may indicate specific slots in which an unavailable time-frequency resource exists, and may occupy two bits, four bits, five bits, eight bits, 10 bits, 20 bits, or 40 bits. This is not limited.

It may be understood that, for detailed descriptions of Case 1 and Case 2, refer to related descriptions in the 3GPP protocol. Details are not described herein.

### 5. Coordinated Multi-Point (Coordinated Multi-Point, CoMP) Transmission

The CoMP may refer to a plurality of geographically separated transmission points cooperatively participating in data transmission of one terminal device or jointly receiving data sent by one terminal device. The plurality of transmission points participating in coordination may generally be base stations of different cells. In other words, in the CoMP, a plurality of base stations jointly provide a service for a terminal device through mutual coordination.

The CoMP may include implementations such as dynamic point selection (dynamic point selection, DPS), coordinated scheduling (coordinated scheduling, CS), coordinated beamforming (coordinated beamforming, CBF), and joint transmission (joint transmission, JT).

The DPS may mean that different base stations use different time domain resources to provide a service for the terminal device. In other words, the terminal device may dynamically select to communicate with different base stations.

The CS may mean that different base stations provide a service for the terminal device on a same time domain resource by using different frequency domain resources. In other words, the terminal device may communicate with different base stations on different subcarriers.

The CBF may mean that a base station of only one cell sends a useful signal to the terminal device, and a base station of a neighboring coordinated cell may adjust a beamforming vector, to mitigate interference to the terminal device.

The JT may mean that a plurality of base stations send a useful signal to the terminal device. The JT may include coherent JT (coherent JT, CJT) and non-coherent JT (non-coherent JT, NCJT). The CJT may mean that a plurality of base stations send a same useful signal to the terminal device. The CJT can achieve very good system performance, but system implementation is difficult as ideal backhaul between base stations is required. The NCJT may mean that a plurality of base stations send different useful signals to the terminal device, and system implementation difficulty is reduced as non-ideal backhaul between base stations is allowed, but there is a performance loss compared with the CJT.

It may be understood that, in a terrestrial communication system, because a distance between a network device and a terminal device is relatively short, and the terminal device moves at a relatively low speed, when downlink signals sent by different network devices arrive at the terminal device, a latency difference between the network devices can be covered in a cyclic prefix (cyclic prefix, CP), and a Doppler frequency shift difference can be covered in a subcarrier spacing (subcarrier spacing, SCS). In this case, when the terminal device performs OFDM demodulation on downlink signals from different network devices, there is no inter-symbol interference (inter-symbol interference, ISI) and inter-subcarrier interference (inter-carrier interference, ICI).

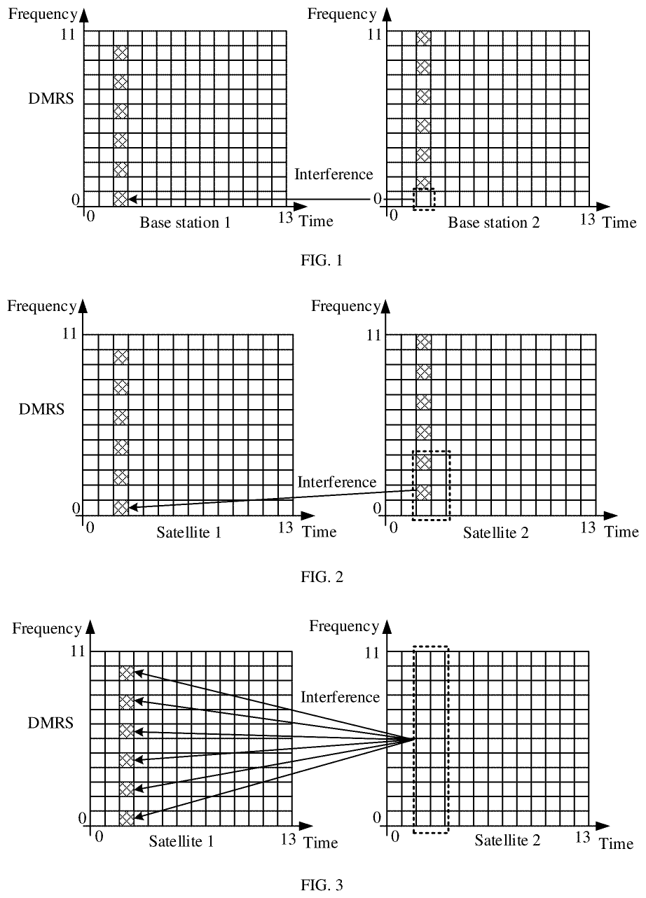

For example, it is assumed that network devices, for example, a base station 1 and a base station 2, in the terrestrial communication system, provide a service for a terminal device #1 in an NCJT manner, and OFDM is used as a modulation scheme. FIG. 1 is a diagram of DMRS time-frequency resource occupation of the base station 1 and the base station 2. As shown in FIG. 1, each small block represents one RE, a time domain width of each RE is time of one OFDM symbol, and a frequency domain width of each RE is an SCS. In time domain, one slot includes 14 OFDM symbols, and symbol indexes may be a symbol #0 to a symbol #13. In frequency domain, one RB includes 12 REs, and RE indexes may be an RE #0 to an RE #11.

Small blocks in shadow parts may indicate that the base station 1 and the base station 2 send downlink signals on these REs, for example, a channel state information reference signal (channel state information reference signal, CSI-RS), a demodulation reference signal (demodulation reference signal, DMRS), a time-frequency tracking reference signal (tracking reference signal, TRS), a phase noise tracking reference signal (phase noise tracking reference signal, PNT-RS), a primary synchronization signal PSS, or a secondary synchronization signal SSS. An example in which the base station 1 and the base station 2 send DMRSs to the terminal device is used. It can be learned that an RE occupied by a DMRS of the base station 1 does not overlap an RE occupied by a DMRS of the base station 2. In other words, the RE occupied by the DMRS of the base station 1 and the RE occupied by the DMRS of the base station 2 are different REs on a same symbol.

In this case, a DMRS on one RE occupied by the base station 1 is only interfered with by a DMRS of a signal on one RE occupied by the base station 2. For example, a DMRS sent by the base station 1 on (symbol #2, RE #0) is only interfered with by a downlink signal sent by the base station 2 on (symbol #2, RE #0).

However, in a satellite communication system, because a distance between a satellite and the ground is relatively long, a terminal device moves at a relatively low speed, and the satellite is always in a high-speed moving state, when downlink signals sent by different satellites arrive at the terminal device on the ground, a latency difference between the satellites cannot be covered in a CP, and a Doppler frequency shift difference cannot be covered in an SCS. In this case, when the terminal device performs OFDM demodulation on downlink signals from different satellites, there are severe ISI and ICI. In addition, as the satellite moves at a high speed, the ISI and the ICI dynamically change, and the ISI and the ICI are usually difficult to predict.

For example, it is assumed that network devices, for example, a satellite 1 and a satellite 2, in the satellite communication system provides a service for a terminal device #a in an NCJT manner, and OFDM is used as a modulation scheme. FIG. 2 is a diagram of DMRS time-frequency resource occupation of the satellite 1 and the satellite 2. As shown in FIG. 2, small blocks in shadow parts may indicate that the satellite 1 and the satellite 2 send downlink signals on these REs. An example in which the satellite #1 and the satellite #2 send DMRSs to the terminal device is used. It can be learned that an RE occupied by a DMRS of the satellite #1 does not overlap an RE occupied by a DMRS of the satellite 2. In other words, the RE occupied by the DMRS of the satellite 1 and the RE occupied by the DMRS of the satellite 2 are different REs on a same symbol.

In this case, a DMRS on one RE occupied by the satellite 1 is interfered with by downlink signals on a plurality of REs occupied by the satellite 2. For example, a DMRS sent by the satellite 1 on (symbol #2, RE #0) may be interfered with by all downlink signals sent by the satellite 2 on (symbol #2, RE #0), (symbol #2, RE #1), (symbol #2, RE #2), (symbol #3, RE #0), (symbol #3, RE #1), and (symbol #3, RE #2).

If the DMRS of the satellite 1 is severely interfered with, a large channel estimation error is caused when the terminal device estimates a channel of the satellite 1, and consequently performance of a signal detector is severely deteriorated, and a throughput rate of the communication system sharply drops. To mitigate interference caused by the satellite 2 to the DMRS of the satellite 1, it is required that the satellite 2 cannot send any signal on some specific time domain resources. As shown in FIG. 3, a symbol #2 and a symbol #3 are time domain resources reserved for the satellite #2, and the satellite 2 does not send any downlink signal on the symbol #2 and the symbol #3, so that the DMRS of the satellite 1 is not interfered with by the satellite 2.

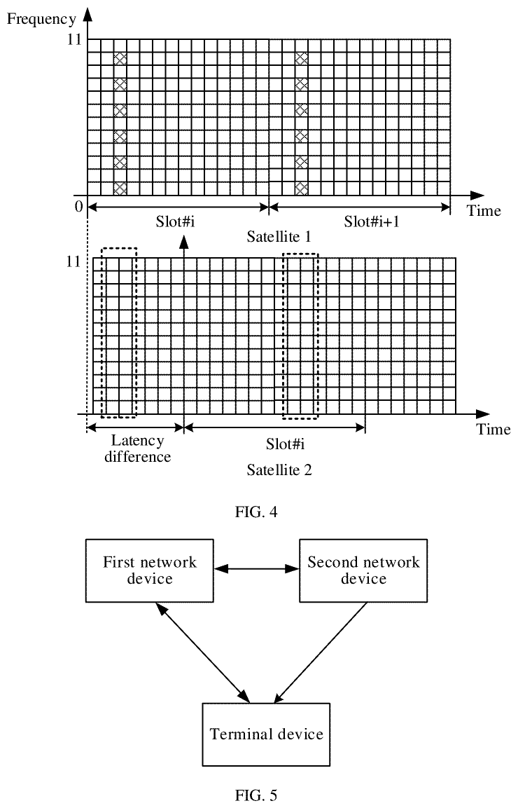

Therefore, the network device needs to assign a non-consecutive time domain resource to the PDSCH in some cases. For example, as shown in FIG. 4, if there is a latency difference of 7.5 OFDM symbols between the satellite 1 and the satellite 2, and the satellite 1 sends the DMRS to the terminal device on (symbol #2, RE #0), (symbol #2, RE #2), (symbol #2, RE #4), (symbol #2, RE #6), (symbol #2, RE #8), and (symbol #2, RE #10) in a slot #i and a slot #i+1, sending a downlink signal by the satellite 2 on a symbol #8 and a symbol #9 in the slot #i causes interference to the DMRS sent by the satellite 1 on the symbol #2 in the slot #i+1. To prevent the DMRS of the satellite 1 from being interfered with by the satellite 2, the satellite 2 cannot send any downlink signal on the symbol #8 and the symbol #9 in the slot #i. In other words, a PDSCH of the satellite 2 can occupy the symbol #2 to a symbol #7 and a symbol #10 to a symbol #13 in the slot #i to send a downlink signal.

However, it can be learned from the foregoing descriptions that the time domain configuration mode in Case 1 can support only assignment of a consecutive time resource. The satellite 2 sends a downlink signal by using either the symbol #2 to the symbol #7 or the symbol #10 to the symbol #13, causing a waste of communication resources.

To implement assignment of a non-consecutive time domain resource, the network device may assign a non-consecutive time domain resource in the time domain configuration mode in Case 2. In other words, the network device may indicate, by using a rate matching pattern field in an RRC message, a location of a downlink time domain resource unavailable to the terminal device. However, with continuous movement of the network device, the network device needs to reconfigure each parameter in the rate matching pattern field in the RRC message at regular intervals, and send a reconfigured rate matching pattern field to the terminal device.

However, if the network device indicates, by reconfiguring the parameter in the rate matching pattern field, a downlink time domain resource segment unavailable to the PDSCH, there is a redundant indication. For example, the network device actually needs to reconfigure only symbolsInResourceBlock in the rate matching pattern field, and resourceBlocks and periodicityAndPattern do not need to be reconfigured. Redundant indication overheads cause transmission efficiency reduction, and cause a redundant configuration of communication signaling, resulting in communication efficiency decline. In addition, because it takes long time for the network device to reconfigure the rate matching pattern field, if the network device needs to reconfigure each parameter in the rate matching pattern field in the RRC message at regular intervals, communication efficiency is further deteriorated.

For the foregoing technical problems, embodiments of this application provide the following technical solutions, to reduce a redundant configuration of communication signaling and improve communication efficiency.

The following describes the technical solutions of embodiments in this application with reference to accompanying drawings.

The technical solutions in embodiments of this application may be applied to various communication systems, for example, a wireless fidelity (wireless fidelity, Wi-Fi) system, a vehicle-to-everything (vehicle-to-everything, V2X) communication system, a device-to-device (device-to-device, D2D) communication system, a 4G, for example, long term evolution (long term evolution, LTE), system, a worldwide interoperability for microwave access (worldwide interoperability for microwave access, WiMAX) communication system, a 5G, for example, new radio, system, and a future communication system.

All aspects, embodiments, or features are presented in embodiments of this application by describing a system that may include a plurality of devices, components, modules, and the like. It should be appreciated and understood that each system may include another device, component, module, and the like, and/or may not include all devices, components, modules, and the like discussed with reference to the accompanying drawings. In addition, a combination of these solutions may be used.

In addition, in embodiments of this application, terms such as “example” or “for example” are for representing giving an example, an illustration, or a description. Any embodiment or design scheme described as an “example” in embodiments of this application should not be explained as being more preferred or having more advantages than another embodiment or design scheme. Exactly, use of the term example is intended to present a concept in a specific manner.

In embodiments of this application, terms “information (information)”, “signal (signal)”, “message (message)”, “channel (channel)”, and “signaling (signaling)” may sometimes be interchangeably used. It should be noted that meanings expressed by the terms are matchable when differences of the terms are not emphasized. Terms “of (of)”, “corresponding, relevant (corresponding, relevant)”, and “corresponding (corresponding)” may be interchangeably used sometimes. It should be noted that meanings expressed by the terms are matchable when differences of the terms are not emphasized. In addition, “/” mentioned in embodiments of this application may indicate an “or” relationship.

It may be understood that in embodiments of this application, an “indication” may include a direct indication, an indirect indication, an explicit indication, or an implicit indication. When a piece of indication information is described as indicating A, it may be understood as that the indication information carries A, directly indicates A, or indirectly indicates A.

In embodiments of this application, information indicated by the indication information is referred to as to-be-indicated information. In a specific implementation process, there are a plurality of manners of indicating the to-be-indicated information. For example, the manners include but are not limited to a manner in which the to-be-indicated information, for example, the to-be-indicated information or an index of the to-be-indicated information, may be directly indicated, or a manner in which the to-be-indicated information may be indirectly indicated by indicating other information. There is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

The to-be-indicated information may be sent as a whole, or may be divided into a plurality of pieces of sub-information for separate sending. In addition, sending periodicities and/or sending occasions of these pieces of sub-information may be the same or may be different.

A specific sending method is not limited in embodiments of this application. The sending periodicities and/or the sending occasions of these pieces of sub-information may be predefined, for example, predefined according to a protocol, or may be configured by a transmitting end device by sending configuration information to a receiving end device.

A network architecture and a service scenario described in embodiments of this application are intended to describe the technical solutions in embodiments of this application more clearly, and do not constitute a limitation on the technical solutions provided in embodiments of this application. A person of ordinary skill in the art may know that, with the evolution of the network architecture and the emergence of new service scenarios, the technical solutions provided in embodiments of this application are also applicable to similar technical problems.

For ease of understanding embodiments of this application, a communication system shown in FIG. 5 is first used as an example to describe in detail a communication system applicable to embodiments of this application. For example, FIG. 5 is a first diagram of an architecture of a communication system to which a communication method according to an embodiment of this application is applicable.

As shown in FIG. 5, the communication system mainly includes a network device and a terminal device.

There may be a plurality of network devices, for example, a first network device and a second network device. Without ambiguity, the network device in this embodiment of this application may be a device having a wireless transceiver function, or may be a chip or a chip system of the device, and is located in an access network (access network, AN) of the communication system, to provide an access service for the terminal. For example, the network device may be referred to as a radio access network (radio access network, RAN) device, and may be specifically an access network device in a next-generation mobile communication system, for example, a 6G mobile communication system. For example, the network device may be a 6G base station. Alternatively, in the next-generation mobile communication system, the network device may be named in another manner, which falls within the protection scope of embodiments of this application. This is not limited in this application. Alternatively, the network device may include a gNB in 5G, for example, a new radio (new radio, NR) system, may include one or a group of antenna panels (including a plurality of antenna panels) of a base station in 5G, or may be a network node that forms a gNB, a transmission point (transmission and reception point, TRP, or transmission point, TP), or a transmission measurement function (transmission measurement function, TMF). For example, the network device may be a central unit (central unit, CU), a distributed unit (distributed unit, DU), a CU-control plane (control plane, CP), a CU-user plane (user plane, UP), a radio unit (radio unit, RU), an RSU having a base station function, a wired access gateway, or a 5G core network element. Alternatively, the network device may include an access point (access point, AP), a wireless relay node, a wireless backhaul node, macro base stations in various forms, a micro base station (also referred to as a small cell), a relay station, an access point, a wearable device, a vehicle-mounted device, and the like in a wireless fidelity (wireless fidelity, Wi-Fi) system.

The CU and the DU may be separately disposed, or may be included in a same network element, for example, a baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH). It may be understood that the network device may be a CU node, a DU node, or a device including the CU node and the DU node. In addition, the CU may be classified as a network device in an access network RAN, or the CU may be classified as a network device in a core network. This is not limited herein.

In different systems, the CU (or the CU-CP and the CU-UP), the DU, or the RU may alternatively have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of the software module and the hardware module.

A form of the network device is not limited in embodiments of this application. An apparatus for implementing a function of the network device may be a network device, or may be an apparatus, for example, a chip system, that supports the network device in implementing the function. The apparatus may be mounted in the network device or used in conjunction with the network device.

Without ambiguity, the terminal device in embodiments of this application may be a terminal device having a transceiver function, or may be a chip or chip system of the terminal device. The terminal device may also be referred to as user equipment (user equipment, UE), an access terminal device, a subscriber unit (subscriber unit), a subscriber station, a mobile station (mobile station, MS), a mobile console, a remote station, a remote terminal device, a mobile device, a user terminal device, a terminal device, a wireless communication device, a user agent, or a user apparatus. The terminal device in embodiments of this application may be a mobile phone (mobile phone), a cellular phone (cellular phone), a smartphone (smartphone), a tablet computer (Pad), a wireless data card, a personal digital assistant (personal digital assistant, PDA) computer, a wireless modem (modem), a handheld device (handset), a laptop computer (laptop computer), a machine type communication (machine type communication, MTC) terminal device, a computer having a wireless transceiver function, a virtual reality (virtual reality, VR) terminal device, an augmented reality (augmented reality, AR) terminal device, a smart home device (for example, a refrigerator, a TV, an air conditioner, or a meter), a smart robot, a robot arm, a workshop device, a wireless terminal device in self-driving, a wireless terminal device in industrial control (industrial control), a wireless terminal device in self-driving (self-driving), a wireless terminal device in telemedicine (remote medical), a wireless terminal device in a smart grid (smart grid), a wireless terminal device in transportation safety (transportation safety), a wireless terminal device in a smart city (smart city), a wireless terminal device in a smart home (smart home), a vehicle-mounted terminal device, a road side unit (road side unit, RSU) or the like having a terminal device function, a flight device (for example, a smart robot, a hot air balloon, an uncrewed aerial vehicle, or an airplane), or the like. The terminal device in this application may alternatively be a vehicle-mounted module, a vehicle-mounted component, a vehicle-mounted chip, or a vehicle-mounted unit that is built in a vehicle as one or more components or units. The terminal device may alternatively be another device having a terminal device function. For example, the terminal device may be a device that functions as a terminal device in D2D communication.

A form of the terminal device is not limited in embodiments of this application. An apparatus for implementing a function of the terminal device may be a terminal device, or may be an apparatus, for example, a chip system, that supports the terminal device in implementing the function. The apparatus may be mounted in the terminal device or used in conjunction with the terminal device. In embodiments of this application, the chip system may include a chip, or may include a chip and another discrete device.

In the communication system, the second network device may send, to the terminal device, a message including at least one non-consecutive time domain resource configuration. A time domain resource indicated by the at least one time domain resource configuration does not include an unavailable downlink time domain resource that is of the second network device and that is reported by the terminal device to the first network device. Therefore, the network device does not need to reconfigure each parameter in a rate matching field each time to indicate an unavailable downlink time domain resource segment. This can shorten time for reconfiguring the rate matching field, and therefore avoid a redundant configuration of communication signaling and improve communication efficiency, to implement flexible time domain resource assignment.

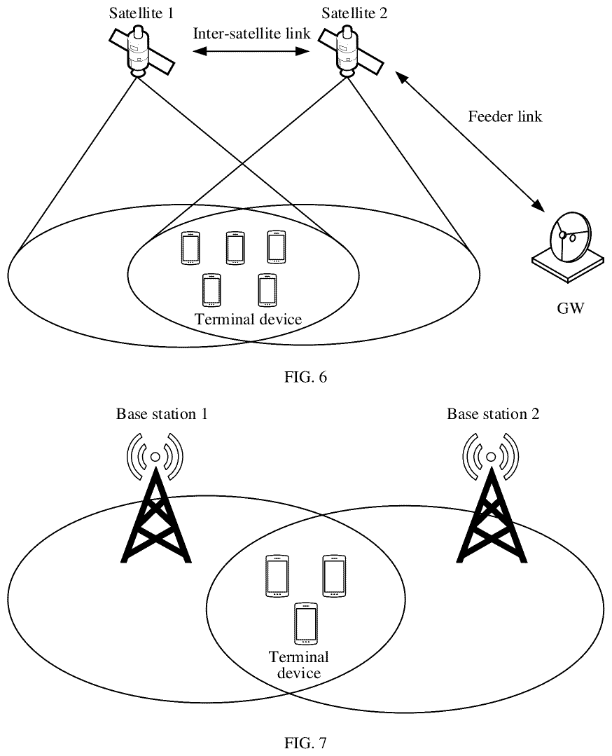

For example, FIG. 6 is a second diagram of an architecture of a communication system to which a communication method according to an embodiment of this application is applicable. As shown in FIG. 6, the communication system is a satellite communication system. The communication system mainly includes a terminal device, a gateway (gateway, GW), and satellites, for example, a satellite 1 and a satellite 2. Both the satellite 1 and the satellite 2 may provide a service for the terminal device.

A link between the satellite and the terminal device may be referred to as a user link, a link between the satellite and the GW may be referred to as a feeder link, and a link between the satellites may be referred to as an inter-satellite link. Operating modes of the satellite may include a transparent (transparent) transmission mode and a regenerative (regenerative) mode. When the satellite operates in the transparent transmission mode, the satellite has only a signal forwarding function, and the GW has a function of a gNB or a part of the function of the gNB. In this case, the GW may be considered as a base station. When the satellite operates in the regenerative mode, the satellite has a capability of processing a digital signal, and the satellite has a function of a gNB or a part of the function of the gNB. In this case, the satellite may be considered as a base station. A plurality of satellites jointly provide a service through coordination for the terminal device in an overlapping coverage area. The satellite may obtain information about an unavailable downlink time domain resource through the inter-satellite link (inter-satellite link, ISL) or the feeder link (feeder link, FL), and send an RRC message and DCI to the terminal device through the user link, to notify the terminal device of information about a non-consecutive time domain resource assigned to the terminal device.

For example, FIG. 7 is a third diagram of an architecture of a communication system to which a communication method according to an embodiment of this application is applicable.

As shown in FIG. 7, the communication system is a terrestrial communication system. The communication system mainly includes a terminal device and base stations, for example, a base station 1 and a base station 2. Both the base station 1 and the base station 2 may provide a service for the terminal device.

It may be understood that FIG. 5 to FIG. 7 are simplified diagrams used as an example for ease of understanding. The communication system may alternatively include another network device and/or another terminal device that are/is not shown in FIG. 5 to FIG. 7.

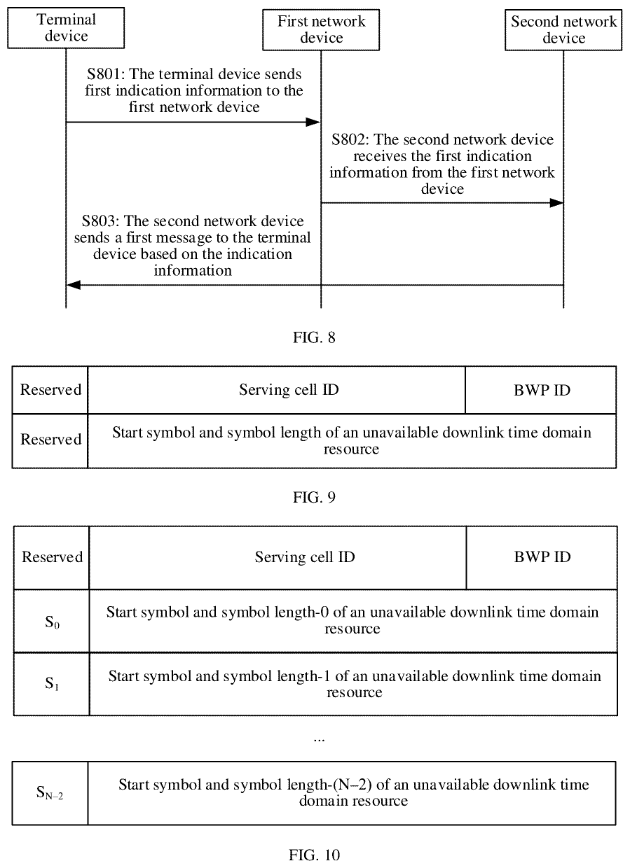

For ease of understanding, the following specifically describes a communication method provided in embodiments of this application with reference to FIG. 8 to FIG. 12.

For example, FIG. 8 is a schematic flowchart of a communication method according to an embodiment of this application. The method is applicable to interaction between the first network device, the second network device, and the terminal device in the foregoing communication system.

Specifically, as shown in FIG. 8, a procedure for the communication method is as follows.

S801: The terminal device sends first indication information to the first network device. Correspondingly, the first network device receives the first indication information from the terminal device.

The first indication information indicates an unavailable downlink time domain resource, and the unavailable downlink time domain resource is an unavailable downlink time domain resource of the second network device.

A cell of the first network device and a cell of the second network device are neighboring cells. In other words, the first network device and the second network device are adjacent or neighboring network devices. In other words, the first network device and the second network device provide a service for the terminal device on a same time-frequency resource through coordination, for example, non-coherent joint transmission. The first network device may be a primary network device that provides a service for the terminal device, and the second network device may be a secondary network device that provides a service for the terminal device.

The unavailable downlink time domain resource may include at least one consecutive time domain resource segment. The at least one consecutive time domain resource segment may be time domain resources in a same time unit. The time unit may be a symbol, a slot, a subframe, a frame, or the like. This is not limited. The consecutive time domain resource may be understood as including time domain resources corresponding to a plurality of consecutive time domain resource locations, or including a time domain resource corresponding to a separate time domain resource location. For example, a symbol #6 to a symbol #8, and a symbol #12 that are in a slot #i are the unavailable downlink time domain resource of the second network device. In this case, the symbol #6 to the symbol #8, and the symbol #12 may be all understood as the consecutive time domain resource. This is not limited. In this embodiment of this application, an example in which the unavailable downlink time domain resource includes a consecutive time domain resource segment is used for description. For example, as shown in FIG. 4, if the first network device is the satellite 1, and the second network device is the satellite 2, the unavailable downlink time domain resource of the satellite 2 is the symbol #8 and the symbol #9 in the slot #i.

It may be understood that the unavailable downlink time domain resource may be determined by the terminal device based on a PDSCH time domain resource configuration of the first network device, a PDSCH time domain resource configuration of the second network device, a latency difference between the first network device and the second device, and the like. For example, as shown in FIG. 4, the terminal device may determine, based on the time domain resource occupied by the DMRS of the satellite 1, the PDSCH time domain resource configuration of the satellite 2, and the latency difference between the satellite 1 and the satellite 2, that the unavailable downlink time domain resource of the satellite 2 is the symbol #8 and the symbol #9 in the slot #i. For a specific implementation process, refer to related descriptions in the foregoing background. Details are not described herein again.

In a possible design solution, when downlink communication between the terminal device and the first network device meets a preset condition, the terminal device sends the first indication information to the first network device. The preset condition may include at least one of the following: a block error rate is greater than a first preset threshold, a signal to interference plus noise ratio is greater than a second preset threshold, a communication rate is less than a third preset threshold, or the like.

The block error rate, the signal to interference plus noise ratio, and the communication rate are all parameters that represent performance of the communication system.

The block error rate (block error rate, BLER) may be a percentage of an error block in all sent blocks in the communication system, or an error probability of a transport block after cyclic redundancy check (cyclic redundancy check, CRC). The first preset threshold may be a reference value of the block error rate, and may be denoted as P1. If a BLER of a downlink signal of the first network device is greater than P1, it may be considered that the second network device causes severe interference to the downlink signal of the first network device. If a BLER of the downlink signal of the first network device is less than or equal to P1, it may be considered that the second network device does not cause interference to the downlink signal of the first network device, or the interference is small, and in this case, it may be considered that the interference caused by the second network device to the downlink signal of the first network device may be ignored. It may be understood that a value of the first preset threshold may be selected based on a specific scenario. This is not limited in this embodiment of this application.

The signal to interference plus noise ratio (signal to interference plus noise ratio, SINR) may be a ratio of a signal to a sum of interference and noise in the communication system, and the SINR may represent signal quality. The second preset threshold may be a reference value of the signal to interference plus noise ratio, and may be denoted as P2. If an SINR of the downlink signal of the first network device is less than or equal to P2, it may be considered that the second network device causes severe interference to the downlink signal of the first network device. If an SINR of the downlink signal of the first network device is greater than P2, it may be considered that the second network device does not cause interference to the downlink signal of the first network device, or the interference is small, and in this case, it may be considered that the interference caused by the second network device to the downlink signal of the first network device may be ignored. It may be understood that a value of the second preset threshold may be selected based on a specific scenario. This is not limited in this embodiment of this application.

The communication rate may be a rate at which the network device transmits a signal to the terminal device. The communication rate may include a bit rate (bit rate), a baud rate (baud rate), a data transfer rate (data transfer rate), and the like. The bit rate may be an amount of information transmitted through a communication line (or system) per unit time (for example, per second). The baud rate may be a quantity of code elements (or pulses) transmitted through the communication line (or system) per unit time (for example, per second). Alternatively, the baud rate may represent a quantity of times of waveform transformation of a modulated signal per unit time in a signal modulation process. The data transfer rate may be a quantity of characters transmitted through the communication line (or system) per unit time (for example, per second), or a quantity of code groups (or word blocks) or bits transmitted per unit time (for example, per second). It may be understood that the communication rate may alternatively include any other possible parameter. This is not limited.

The third preset threshold may be a reference value of the communication rate, for example, a reference value of the bit rate, a reference value of the baud rate, or a reference value of the data transfer rate. The third preset threshold may be denoted as P3. If a communication rate of downlink communication between the first network device and the terminal device is less than P3, it may be considered that the second network device causes severe interference to the downlink signal of the first network device. If a communication rate of the downlink signal of the first network device is greater than P3, it may be considered that the second network device does not cause interference to the downlink signal of the first network device, or the interference is small, and in this case, it may be considered that the interference caused by the second network device to the downlink signal of the first network device may be ignored. It may be understood that a value of the third preset threshold may be selected based on a specific scenario. This is not limited in this embodiment of this application.

It may be understood that, in this embodiment of this application, the preset condition may be a combination of one or more of the foregoing conditions. For example, the terminal device may determine, jointly based on that the block error rate is greater than the first preset threshold and the signal to interference plus noise ratio is greater than the second preset threshold, whether downlink communication with the first network device meets the preset condition. For a specific implementation process, refer to an implementation process of the foregoing parameters. Details are not described herein again. The preset condition may alternatively include any other possible condition. This is not limited.

Optionally, the first indication information may further indicate that downlink communication between the terminal device and the first network device meets the preset condition. In this case, the first network device may determine, based on the first indication information reported by the terminal device, whether interference is caused by the second network device, so that the first network device subsequently schedules a PDSCH time domain resource. For example, after the first network device determines that interference is caused by the second network device, the first network device may selectively send a downlink signal. For example, the first network device may not send a downlink signal (for example, a CSI-RS) on a specific time domain resource, to avoid interference caused by the second network device to the CSI-RS signal of the first network device. It may be understood that a specific implementation of scheduling the PDSCH time domain resource by the first network device is not limited in this embodiment of this application.

A name of the first indication information is merely an example, and the first indication information may also be referred to as indication information #1, indication information #a, or the like. This is not limited.

S802: The first network device sends the first indication information to the second network device. Correspondingly, the second network device receives the first indication information from the first network device.

It may be understood that the first network device may directly forward the first indication information from the terminal device to the second network device, to notify the second network device of the unavailable downlink time domain resource. For example, continue to use the foregoing embodiment. The satellite 1 may send the first indication information to the satellite 2 through an inter-satellite link, to notify the satellite 2 that downlink communication with the terminal device cannot be performed on the symbol #8 and the symbol #9 in the slot #i.

S803: The second network device sends a first message to the terminal device based on the first indication information. Correspondingly, the terminal device receives the first message from the second network device.

The first message may include at least one downlink time domain resource configuration. In other words, the second network device may indicate one or more downlink time domain resource configurations by using the first message. A time domain resource indicated by the at least one downlink time domain resource configuration may be a non-consecutive time domain resource available to downlink communication between the second network device and the terminal device. The terminal device may perform downlink communication with the second network device on the non-consecutive time domain resource indicated by the at least one downlink time domain resource configuration.

The non-consecutive time domain resource may be understood as that there is an interval in a time domain resource occupied by a PDSCH of the second network device. For example, as shown in FIG. 4, a non-consecutive time domain resource assigned by the satellite 2 to the PDSCH may be denoted as a time domain resource a. The time domain resource a may be a symbol #2 to a symbol #7 and a symbol #10 to a symbol #13 that are in the slot #i, and there are intervals between the symbol #2 to the symbol #7 and the symbol #10 to the symbol #13.

The time domain resource indicated by the at least one time domain resource configuration may not include the unavailable downlink time domain resource. For example, a first time domain resource in the time domain resource indicated by the at least one time domain resource configuration may not include the unavailable downlink time domain resource. In other words, a time domain interval in a non-consecutive time domain resource indicated by a first time domain resource configuration may include the unavailable downlink time domain resource. For example, continue to use the foregoing embodiment. The satellite 2 may indicate the non-consecutive time domain resource a by using the first time domain resource configuration, and the non-consecutive time domain resource a does not include an unavailable downlink time domain resource of the satellite 2: the symbol #8 and the symbol #9.

It may be understood that the first message carries information that may indicate a consecutive time domain resource. The information that indicates a consecutive time domain resource may be pdsch-AllocationList. The information indicating a consecutive time domain resource may further indicate a plurality of time domain resource configurations. In other words, pdsch-AllocationList may further indicate a plurality of non-consecutive time domain resource configurations. That pdsch-AllocationList may indicate a plurality of non-consecutive time domain resource configurations may be understood as that the second network device may directly reuse pdsch-AllocationList to indicate the plurality of non-consecutive time domain resource configurations, or may indicate the plurality of non-consecutive time domain resource configurations by using pdsch-AllocationList and other information jointly, such as a medium access control-control element (medium access control, MAC-CE). The following uses the following six cases of the first time domain resource configuration as an example for detailed description.

Case a: The first time domain resource configuration may include a bitmap (bitmap), and the bitmap may be carried in time domain resource configuration information.

The time domain resource configuration information may indicate the first time domain resource configuration by reusing PDSCH-TimeDomainResourceAllocation in pdsch-AllocationList. pdsch-AllocationList herein is denoted as pdsch-AllocationList #2, and PDSCH-TimeDomainResourceAllocation in pdsch-AllocationList #2 may be denoted as PDSCH-TimeDomainResourceAllocation #21, PDSCH-TimeDomainResourceAllocation #22, . . . , and PDSCH-TimeDomainResourceAllocation #2n. A value of n is any integer greater than or equal to 1.

It may be understood that each of PDSCH-TimeDomainResourceAllocation #21, PDSCH-TimeDomainResourceAllocation #22, and PDSCH-TimeDomainResourceAllocation #2n may indicate one time domain resource configuration. It is assumed that a time domain resource indicated by the first time domain resource configuration may be indicated by using PDSCH-TimeDomainResourceAllocation #21. The following uses PDSCH-TimeDomainResourceAllocation #21 as an example for description.

PDSCH-TimeDomainResourceAllocation #21 may include the following parameters: k0, mappingType, and bitmap. Meanings of k0 and mapping Type are the same as meanings in the foregoing technical term “pdsch-AllocationList #1”. Details are not described herein again.

A difference between PDSCH-TimeDomainResourceAllocation #21 and PDSCH-TimeDomainResourceAllocation in pdsch-AllocationList #1, for example, PDSCH-TimeDomainResourceAllocation #11, lies in that, in this embodiment of this application, startSymbolAndLength in PDSCH-TimeDomainResourceAllocation #11 is replaced with a bitmap, and a value of the bitmap may indicate the time domain resource indicated by the first time domain resource configuration. It may be understood that pdsch-AllocationList #2 may be in the following format:

```
pdsch-AllocationList#2{
  PDSCH-TimeDomainResourceAllocation#21{
    k0
    mappingType
    bitmap
  }
  PDSCH-TimeDomainResourceAllocation#22{
    k0
    mappingType
    bitmap
  }
  ...
}
```

The bitmap may include a plurality of bits, and each bit may correspond to one symbol. A value of the bit may indicate whether a symbol corresponding to the bit is an available time domain resource of the second network device. For example, that the value of the bit is 1 may indicate that the symbol indicated by the bit is an available time domain resource of the second network device, and that the value of the bit is 0 may indicate that the symbol indicated by the bit is an unavailable downlink time domain resource of the second network device. In this case, the plurality of bits in the bitmap may jointly indicate the time domain resource indicated by the first time domain resource configuration. For example, continue to use the foregoing example. The bitmap may include 14 bits, and the 14 bits sequentially correspond to a symbol #0 to a symbol #13 in the slot #i from left to right. If a value of the bitmap is 00111111001111, the bitmap may indicate that the symbol #2 to the symbol #7 and the symbol #10 to the symbol #13 in the slot #i is a time domain resource available to the PDSCH of the satellite 2. In other words, a downlink time domain resource unavailable to the PDSCH of the satellite 2 is the symbol #8 and the symbol #9.

It may be understood that an implementation principle of indicating the non-consecutive time domain resource configuration by using PDSCH-TimeDomainResourceAllocation #22, . . . , and PDSCH-TimeDomainResourceAllocation #2n is similar to that using PDSCH-TimeDomainResourceAllocation #21. Reference may be made for understanding. Details are not described again.

Case b: The first time domain resource configuration may include first information and second information. The first information and the second information may be carried in time domain resource configuration information. The first information is start symbol and symbol length information of a configured time domain resource, and the second information is start symbol and symbol length information of an unavailable time domain resource.

The time domain resource configuration information may indicate the first time domain resource configuration by reusing PDSCH-TimeDomainResourceAllocation in pdsch-AllocationList. pdsch-AllocationList herein is denoted as pdsch-AllocationList #3, and PDSCH-TimeDomainResourceAllocation in pdsch-AllocationList #3 may be denoted as PDSCH-TimeDomainResourceAllocation #31, PDSCH-TimeDomainResource Allocation #32, . . . , and PDSCH-TimeDomainResourceAllocation #3n. A value of n is any integer greater than or equal to 1.

It may be understood that each of PDSCH-TimeDomainResourceAllocation #31, PDSCH-TimeDomainResourceAllocation #32, and PDSCH-TimeDomainResourceAllocation #3n may indicate one time domain resource configuration. It is assumed that a time domain resource indicated by the first time domain resource configuration is indicated by using PDSCH-TimeDomainResourceAllocation #31. In other words, the first information and the second information are carried in PDSCH-TimeDomainResourceAllocation #31 information. The following uses PDSCH-TimeDomainResourceAllocation #31 as an example for description.

PDSCH-TimeDomainResourceAllocation #31 may include the following parameters: k0, mappingType, startSymbolAndLength, and start symbol and symbol length of an unavailable time domain resource (unavailableStartSymbolAndLength). Meanings of k0, mappingType, and startSymbolAndLength are the same as meanings in the foregoing technical term “pdsch-AllocationList #1”. Details are not described herein again.

A difference between PDSCH-TimeDomainResourceAllocation #31 and PDSCH-TimeDomainResource Allocation in pdsch-AllocationList #1, for example, PDSCH-TimeDomainResourceAllocation #11, lies in that, in this embodiment of this application, a parameter unavailableStartSymbolAndLength is added to PDSCH-TimeDomainResourceAllocation #11. pdsch-AllocationList #3 may be in the following format:

```
pdsch-AllocationList#3{
  PDSCH-TimeDomainResourceAllocation#31{
    k0
    mappingType
    startSymbolAndLength
    unavailableStartSymbolAndLength
  }
  PDSCH-TimeDomainResourceAllocation#32{
    k0
    mappingType
    unavailableStartSymbolAndLength
  }
  ...
}
```

It may be understood that the first information may be start symbol and symbol length information of the configured time domain resource (that is, the parameter startSymbolAndLength in PDSCH-TimeDomainResourceAllocation #31). startSymbolAndLength may indicate a time domain resource configured for downlink communication between the terminal device and the second network device. The configured time domain resource is a time domain resource configured when the second network device does not consider to cause interference to another network device or the second network device causes small interference to another network device. For example, continue to use the foregoing example. As shown in FIG. 4, the satellite 2 may indicate, by using startSymbolAndLength, that a start symbol of a configured PDSCH time domain resource is the symbol #2, and a symbol length of the configured PDSCH time domain resource is 11. In this case, the PDSCH time domain resource configured by the satellite 2 is the symbol #2 to the symbol #13 in the slot #i.

The second information may be the start symbol and symbol length information (that is, the parameter unavailableStartSymbolAndLength in PDSCH-TimeDomainResourceAllocation #31) of the unavailable time domain resource. unavailableStartSymbolAndLength may indicate the unavailable downlink time domain resource. For example, continue to use the foregoing example. As shown in FIG. 4, the satellite 2 may indicate, by using unavailableStartSymbolAndLength, that a start symbol of an unavailable PDSCH time domain resource is the symbol #8, and a symbol length of the unavailable PDSCH time domain resource is 2. In this case, the unavailable time domain resource of the satellite 2 is the symbol #8 and the symbol #9 in the slot #i.

The configured time domain resource may include the unavailable downlink time domain resource. In other words, the unavailable downlink time domain resource may be considered as a subset of the configured time domain resource. For example, continue to use the foregoing embodiment. The symbol #8 and the symbol #9 are a subset of the symbol #2 to the symbol #13, and the time domain resource indicated by the first time domain resource configuration may be a time domain resource other than the symbol #8 and the symbol #9 in the symbol #2 to the symbol #13. In other words, the time domain resource indicated by the first time domain resource configuration is the symbol #2 to the symbol #8 and the symbol #10 to the symbol #13.

It may be understood that an implementation principle of indicating the non-consecutive time domain resource configuration by using PDSCH-TimeDomainResourceAllocation #32, . . . , and PDSCH-TimeDomainResourceAllocation #3n is similar to that using PDSCH-TimeDomainResourceAllocation #31. Reference may be made for understanding. Details are not described again.

Case c: The first time domain resource configuration may include first information and second information. The first information may be time domain resource configuration information, and the second information may be an information element in a medium access control-control element MAC-CE.

The time domain resource configuration information may be any PDSCH-TimeDomainResourceAllocation in pdsch-AllocationList #1 in the foregoing technical term part, for example, PDSCH-TimeDomainResourceAllocation #11. In other words, the first information may be a parameter startSymbolAndLength in PDSCH-TimeDomainResourceAllocation #11. startSymbolAndLength may indicate a time domain resource configured for downlink communication between the terminal device and the second network device. For the configured time domain resource, refer to related descriptions of Case b. Details are not described again.

FIG. 9 is a first diagram of a structure of an unavailable downlink time domain resource configured by using a MAC-CE according to an embodiment of this application. As shown in FIG. 9, the MAC-CE may be a bit string, and the bit string may include a bit group #la and a bit group #2a. The bit group #la may be understood as a 1^{st} row of the MAC-CE, and the bit group #2a may be understood as a 2^{nd} row of the MAC-CE. The bit group #1a and the bit group #2a may each include eight bits, and are aligned in arrangement.

The bit group #1a may include a reserved (reserved) bit, a serving cell (serving cell) identity (identity, ID), and a bandwidth part (bandwidth part, BWP) ID.

The reserved bit may be a bit that is not defined, or a bit that is reserved for subsequent direct use, occupies one bit in total, and may be denoted as R.

The serving cell ID may indicate an identity of the cell of the second network device, and occupies five bits in total.

The BWP ID may indicate an identity of a bandwidth part of the second network device, and occupies two bits in total.

It may be understood that signaling included in the bit group #la is merely an example, and the bit group #1 may alternatively include any other possible information or signaling. This is not limited.

The bit group #2a may include a reserved bit and start symbol and symbol length information of the unavailable downlink time domain resource (notAvailableStartSymbolAndLength).

The reserved bit may be a bit that is not defined, or a bit that is reserved for subsequent direct use, and occupies one bit in total. For example, the reserved bit may be an activation identifier, denoted as S, and may indicate activation information of an unavailable downlink time domain resource. If S=1, it indicates that the unavailable downlink time domain resource is activated, or the unavailable downlink time domain resource is valid, and the second network device cannot send a downlink signal on the unavailable downlink time domain resource. If S=0, it indicates that the unavailable downlink time domain resource is deactivated, or the unavailable downlink time domain resource is invalid, and the second network device may send a downlink signal on the unavailable downlink time domain resource.

notAvailableStartSymbolAndLength may indicate the unavailable downlink time domain resource, and occupies seven bits in total. notAvailableStartSymbolAndLength and the serving cell ID may jointly indicate that the unavailable downlink time domain resource is an unavailable downlink time domain resource of the second network device. It may be understood that the second information is the information element notAvailableStartSymbolAndLength in the MAC-CE. For example, to continue use the foregoing embodiment. notAvailableStartSymbolAndLength may indicate that a start symbol is the symbol #8, and a symbol length is 2. In this case, the unavailable time domain resource of the satellite 2 is the symbol #8 and the symbol #9 in the slot #i.

In this case, a time domain resource indicated by the first time domain resource configuration may be jointly indicated by using the parameter startSymbolAndLength in PDSCH-TimeDomainResourceAllocation #11 and notAvailableStartSymbolAndLength in the MAC-CE. For example, continue to use the foregoing example. The symbol #8 and the symbol #9 are a subset of the symbol #2 to the symbol #13, and the time domain resource indicated by the first time domain resource configuration may be a time domain resource other than the symbol #8 and the symbol #9 in the symbol #2 to the symbol #13. In other words, the time domain resource indicated by the first time domain resource configuration is the symbol #2 to the symbol #8 and the symbol #10 to the symbol #13.

Optionally, the MAC-CE may further indicate a plurality of unavailable downlink time domain resource configurations. For example, FIG. 10 is a second diagram of a structure of an unavailable downlink time domain resource configured by using a MAC-CE according to an embodiment of this application. As shown in FIG. 10, the MAC-CE may be a bit string, and the bit string may include a plurality of bit groups, for example, a bit group #1b, a bit group #2b, a bit group #3b, . . . , and a bit group #Nb. The bit group #1b may be understood as a 1^{st} row of the MAC-CE, the bit group #2b may be understood as a 2^{nd} row of the MAC-CE, the bit group #3b may be understood as a 3^{rd} row of the MAC-CE, and by analogy, the bit group #Nb may be understood as an N^{th} row of the MAC-CE. The bit group #1b, the bit group #2b, the bit group #3b, . . . , and the bit group #Nb may each include eight bits, and are aligned in arrangement.

A structure of the bit group #1b is the same as that of the bit group #1a. Reference may be made for understanding. Details are not described again.

The bit group #2b may include an activation identifier (denoted as S0) and information #0 about the unavailable downlink time domain resource (denoted as notAvailableStartSymbolAndLength-0).

S0 may indicate activation information of the unavailable downlink time domain resource, and occupies one bit in total. If S0=1, it indicates that the notAvailableStartSymbolAndLength-0 configuration is activated, or the notAvailableStartSymbolAndLength-0 configuration is valid, and the second network device cannot send a downlink signal on a time domain resource indicated by notAvailableStartSymbolAndLength-0. If S0=0, it indicates that the notAvailableStartSymbolAndLength-0 configuration is deactivated, or the notAvailableStartSymbolAndLength-0 configuration is invalid, and the second network device may send a downlink signal on a time domain resource indicated by the unavailable downlink time domain resource.

notAvailableStartSymbolAndLength-0 indicates a 1^{st} unavailable time domain resource configuration. For example, continue to use the foregoing embodiment. notAvailableStartSymbolAndLength-0 may indicate that a start symbol is the symbol #8, and a symbol length is 2. In this case, the unavailable downlink time domain resource of the satellite 2 is the symbol #8 and the symbol #9 in the slot #i.

It may be understood that structures and indication manners of the bit group #3b to the bit group #Nb are the same as those of the bit group #2b. For example, the bit group #3b may include an activation identifier S1 and notAvailableStartSymbolAndLength-1, and by analogy, the bit group #Nb may include SN-2 and notAvailableStartSymbolAndLength-(N-2). Reference may be made for understanding. Details are not described again.

It may be understood that, for example, continue to use the foregoing embodiment and assuming that the satellite 2 indicates, by using the parameter startSymbolAndLength in PDSCH-TimeDomainResourceAllocation #11, that a start symbol of the configured time domain resource is the symbol #2, and a symbol length of the configured time domain resource is 11, and the satellite 2 indicates, by using notAvailableStartSymbolAndLength-0 in the MAC-CE, that a start symbol of the unavailable downlink time domain resource is the symbol #8, and a symbol length of the unavailable downlink time domain resource is 2, S0=1, and values of S1 to SN-2 are all 0. In other words, unavailable downlink time domain resource configurations indicated by notAvailableStartSymbolAndLength-1 to notAvailableStartSymbolAndLength-(N-2) are invalid. In this case, the time domain resource indicated by the first time domain resource configuration may be the symbol #2 to the symbol #8 and the symbol #10 to the symbol #13.

The foregoing implementation process of jointly indicating the first time domain resource configuration by using PDSCH-TimeDomainResourceAllocation #11 in pdsch-AllocationList #1 and the MAC-CE is merely an example. The first time domain resource configuration may alternatively be jointly indicated by using other PDSCH-TimeDomainResourceAllocation in pdsch-AllocationList #1, for example, PDSCH-TimeDomainResourceAllocation #12 and the MAC-CE. Reference may be made for understanding, and this is not limited.

Case d: The first time domain resource configuration may include first information and second information. The first information and the second information may be carried in time domain resource configuration information. The first information indicates a first time domain resource, and the second information indicates a second time domain resource. The first information is start symbol and symbol length information of the first time domain resource, and the second information is start symbol and symbol length information of the second time domain resource.

The time domain resource configuration information may indicate the first time domain resource configuration by reusing PDSCH-TimeDomainResourceAllocation in pdsch-AllocationList. pdsch-AllocationList herein is denoted as pdsch-AllocationList #4, and PDSCH-TimeDomainResourceAllocation in pdsch-AllocationList #4 may be denoted as PDSCH-TimeDomainResourceAllocation #41, PDSCH-TimeDomainResourceAllocation #42, . . . , and PDSCH-TimeDomainResourceAllocation #4n. A value of n is any integer greater than or equal to 1.

It may be understood that each of PDSCH-TimeDomainResourceAllocation #41, PDSCH-TimeDomainResourceAllocation #42, and PDSCH-TimeDomainResourceAllocation #4n may indicate one time domain resource configuration. It is assumed that a time domain resource indicated by the first time domain resource configuration is indicated by using PDSCH-TimeDomainResourceAllocation #41. In other words, the first information and the second information are carried in PDSCH-TimeDomainResourceAllocation #41. The following uses PDSCH-TimeDomainResourceAllocation #41 as an example for description.

PDSCH-TimeDomainResourceAllocation #41 may include the following parameters: k0, mappingType, startSymbolAndLength, and start symbol and symbol length of an additional time domain resource (additionalStartSymbolAndLength). Meanings of k0, mappingType, and startSymbolAndLength are the same as meanings in the foregoing technical term “pdsch-AllocationList #1”. Details are not described herein again.

A difference between PDSCH-TimeDomainResourceAllocation #41 and PDSCH-TimeDomainResourceAllocation in pdsch-AllocationList #1, for example, PDSCH-TimeDomainResourceAllocation #11, lies in that, in this embodiment of this application, a parameter additionalStartSymbolAndLength is added to PDSCH-TimeDomainResourceAllocation #41. pdsch-AllocationList #4 may be in the following format:

```
pdsch-AllocationList#4{
  PDSCH-TimeDomainResourceAllocation#41{
    k0
    mappingType
    startSymbolAndLength
    additionalStartSymbolAndLength
  }
  PDSCH-TimeDomainResourceAllocation#42{
    k0
    mappingType
    additionalStartSymbolAndLength
  }
  ...
}
```

It may be understood that the first information may be the start symbol and symbol length information of the first time domain resource (that is, the parameter startSymbolAndLength in PDSCH-TimeDomainResourceAllocation #41). The first time domain resource may include at least one consecutive time domain resource segment in the time domain resource indicated by the first time domain resource configuration. In other words, startSymbolAndLength may indicate at least one consecutive time domain resource segment in the time domain resource indicated by the first time domain resource configuration. For example, continue to use the foregoing example. The satellite 2 may indicate, by using startSymbolAndLength, that a start symbol of the first time domain resource is the symbol #2, and a symbol length of the first time domain resource is 5. In this case, the first time domain resource may be the symbol #2 to the symbol #7 in the slot #i.

The second information may be the start symbol and symbol length information of the second time domain resource (that is, the parameter additionalStartSymbolAndLength in PDSCH-TimeDomainResourceAllocation #41). The second time domain resource may include a time domain resource other than the at least one consecutive time domain resource segment in the time domain resource indicated by the first time domain resource configuration. In other words, additionalStartSymbolAndLength may indicate a time domain resource other than the at least one consecutive time domain resource segment in the time domain resource indicated by the first time domain resource configuration. For example, continue to use the foregoing example. The satellite 2 may indicate, by using additionalStartSymbolAndLength, that a start symbol of the second time domain resource is the symbol #10, and a symbol length of the second time domain resource is 3. In this case, the second time domain resource may be the symbol #10 to the symbol #13 in the slot #i.

In this case, the time domain resource indicated by the first time domain resource configuration may include the first time domain resource and the second time domain resource. For example, continue to use the foregoing embodiment. The time domain resource indicated by the first time domain resource configuration may include the symbol #2 to the symbol #7 and the symbol #10 to the symbol #13.

It may be understood that an implementation principle of indicating the non-consecutive time domain resource configuration by using PDSCH-TimeDomainResourceAllocation #42, . . . , and PDSCH-TimeDomainResourceAllocation #4n is similar to that using PDSCH-TimeDomainResourceAllocation #41. Reference may be made for understanding. Details are not described again.

Case e: The first time domain resource configuration may include first information and second information. The first information indicates a first time domain resource, and the second information indicates a second time domain resource. The first information may be time domain resource configuration information, and the second information may be an information element in a medium access control-control element MAC-CE.

The time domain resource configuration information may be any PDSCH-TimeDomainResourceAllocation in pdsch-AllocationList #1 in the foregoing technical term part, for example, PDSCH-TimeDomainResourceAllocation #11. In other words, the first information may be a parameter startSymbolAndLength in PDSCH-TimeDomainResourceAllocation #11. startSymbolAndLength may indicate the first time domain resource, and the first time domain resource may include at least one consecutive time domain resource segment in a time domain resource indicated by the first time domain resource configuration. For example, continue to use the foregoing example. The satellite 2 may indicate, by using startSymbolAndLength, that a start symbol of the first time domain resource is the symbol #2, and a symbol length of the first time domain resource is 5. In this case, the first time domain resource may be the symbol #2 to the symbol #7 in the slot #i.

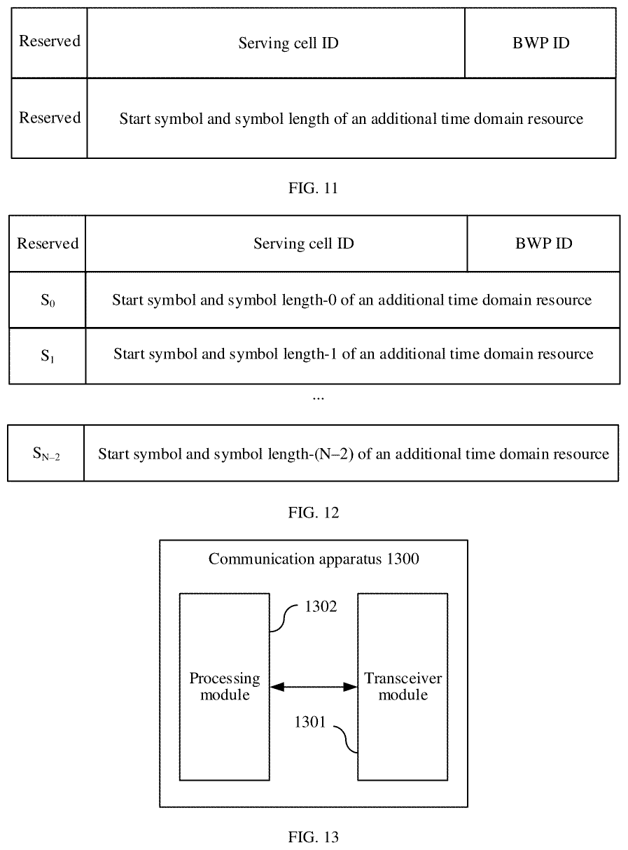

FIG. 11 is a first diagram of a structure of an additional downlink time domain resource configured by using a MAC-CE according to an embodiment of this application. As shown in FIG. 11, the MAC-CE may be a bit string, and the bit string may include a bit group #1c and a bit group #2c. The bit group #1c may be understood as a 1^{st} row of the MAC-CE, and the bit group #2c may be understood as a 2^{nd} row of the MAC-CE. The bit group #1c and the bit group #2c may each include eight bits, and are aligned in arrangement.

A structure of the bit group #1c is the same as that of the bit group #la. Reference may be made for understanding. Details are not described again.

The bit group #2c may include a reserved bit and start symbol and symbol length information of the additional time domain resource (additionalStartSymbolAndLength).

The reserved bit may be a bit that is not defined, or a bit that is reserved for subsequent direct use, and occupies one bit in total. For example, the reserved bit may be an activation identifier, denoted as S, may indicate activation information of the additional downlink time domain resource, and may be denoted as S. If S=1, it indicates that the additional downlink time domain resource is activated, or the additional downlink time domain resource is valid, and the second network device may send a downlink signal on the additional time domain resource. If S=0, it indicates that the additional downlink time domain resource is deactivated, or the additional downlink time domain resource is invalid, and the second network device cannot send a downlink signal on the additional time domain resource.

additionalStartSymbolAndLength may indicate the additional downlink time domain resource, and occupies seven bits in total. additionalStartSymbolAndLength and a serving cell ID may jointly indicate that the additional downlink time domain resource is an available downlink time domain resource of the second network device. It may be understood that the second information is the information element additionalStartSymbolAndLength in the MAC-CE. In other words, start symbol and symbol length information of the second time domain resource may be additionalStartSymbolAndLength. additionalStartSymbolAndLength may indicate a time domain resource other than at least one consecutive time domain resource segment in a time domain resource indicated by the first time domain resource configuration. For example, continue to use the foregoing embodiment. additionalStartSymbolAndLength may indicate that a start symbol of the second time domain resource is the symbol #10, and a symbol length of the second time domain resource is 3. In this case, the second time domain resource may be the symbol #10 to the symbol #13 in the slot #i.

In this case, the time domain resource indicated by the first time domain resource configuration may include the first time domain resource and the second time domain resource. For example, continue to use the foregoing embodiment. The time domain resource indicated by the first time domain resource configuration may include the symbol #2 to the symbol #7 and the symbol #10 to the symbol #13.

Optionally, the MAC-CE may further indicate a plurality of additional downlink time domain resource configurations. For example, FIG. 12 is a second diagram of a structure of an additional downlink time domain resource configured by using a MAC-CE according to an embodiment of this application. As shown in FIG. 12, the MAC-CE may be a bit string, and the bit string may include a plurality of bit groups, for example, a bit group #1d, a bit group #2d, a bit group #3d, . . . , and a bit group #Nd. The bit group #1d may be understood as a 1^{st} row of the MAC-CE, the bit group #2d may be understood as a 2^{nd} row of the MAC-CE, the bit group #3d may be understood as a 3rd row of the MAC-CE, and by analogy, the bit group #Nd may be understood as an N^{th} row of the MAC-CE. The bit group #1d, the bit group #2d, the bit group #3d, . . . , and the bit group #Nd may each include eight bits, and are aligned in arrangement.

A structure of the bit group #1d is the same as that of the bit group #la. Reference may be made for understanding. Details are not described again.

The bit group #2d may include an activation identifier (denoted as S0) and information #0 about the additional downlink time domain resource (denoted as additionalStartSymbolAndLength-0).

S0 may indicate activation information of the additional downlink time domain resource. In other words, S0 may occupies one bit in total. If S0=1, it indicates that the additionalStartSymbolAndLength-0 configuration is activated, or the additionalStartSymbolAndLength-0 configuration is valid, and the second network device may send a downlink signal on a time domain resource indicated by additionalStartSymbolAndLength-0. If S0=0, it indicates that the additionalStartSymbolAndLength-0 configuration is deactivated, or the additionalStartSymbolAndLength-0 configuration is invalid, and the second network device cannot send a downlink signal on a time domain resource indicated by the unavailable downlink time domain resource.

additionalStartSymbolAndLength-0 indicates a 1^{st} additional time domain resource configuration. For example, continue to use the foregoing embodiment. additionalStartSymbolAndLength-0 may indicate that a start symbol is the symbol #10, and a symbol length is 3. In this case, the second time domain resource of the satellite 2 may be the symbol #10 to the symbol #13 in the slot #i.

It may be understood that structures and indication manners of the bit group #3d to the bit group #Nd are the same as those of the bit group #2d. For example, the bit group #3d may include an activation identifier S1 and additionalStartSymbolAndLength-1, and by analogy, the bit group #Nd may include SN-2 and additionalStartSymbolAndLength-(N-2). Reference may be made for understanding. Details are not described again.

It may be understood that, for example, continue to use the foregoing embodiment and assuming that the satellite 2 indicates, by using the parameter startSymbolAndLength in PDSCH-TimeDomainResourceAllocation #11, that a start symbol of the first time domain resource is the symbol #2, and a symbol length of the first time domain resource is 5, and the satellite 2 indicates, by using notAvailableStartSymbolAndLength-0 in the MAC-CE, that a start symbol of the second time domain resource is the symbol #10, and a symbol length of the second time domain resource is 3, S0=1, and values of S1 to SN-2 are all 0. In other words, additional time domain resource configurations indicated by additionalStartSymbolAndLength-1 to additionalStartSymbolAndLength-(N-2) are invalid. In this case, the time domain resource indicated by the first time domain resource configuration may be the symbol #2 to the symbol #8 and the symbol #10 to the symbol #13.

The foregoing implementation process of jointly indicating the first time domain resource configuration by using pdsch-AllocationList #1 and the MAC-CE is merely an example. The first time domain resource configuration may alternatively be jointly indicated by using other PDSCH-TimeDomainResourceAllocation in pdsch-AllocationList #1, for example, PDSCH-TimeDomainResourceAllocation #12 and the MAC-CE. Reference may be made for understanding, and this is not limited.

Optionally, the first message may be carried in at least one of the following: an RRC message, DCI, a MAC-CE, or a system information block (system information block, SIB) 1. In other words, the second network device may send the first message to the terminal device based on an RRC message, DCI, a MAC-CE, or a SIB1. This is not limited.

A name of the first message is merely an example, and the first message may also be referred to as a message #1, a message #a, or the like. This is not limited.

It may be understood that the foregoing uses the six cases of the first time domain resource configuration as an example for description. A principle of indicating, by another time domain resource configuration in the at least one downlink time domain resource configuration, an unavailable non-consecutive time domain resource is the same as that of the first time domain resource configuration. For a specific implementation, refer to an implementation process of indicating, by the first time domain resource configuration, an unavailable non-consecutive time domain resource. Details are not described again.

In conclusion, the second network device may send, to the terminal device, a message including at least one non-consecutive time domain resource configuration. A time domain resource indicated by the at least one time domain resource configuration does not include the unavailable downlink time domain resource that is of the second network device and that is reported by the terminal device to the first network device. Therefore, the network device does not need to reconfigure each parameter in a rate matching field each time to indicate an unavailable downlink time domain resource segment. This can shorten time for reconfiguring the rate matching field, and therefore reduce a redundant configuration of communication signaling and improve communication efficiency, to implement flexible time domain resource assignment.

With reference to the foregoing embodiment, the method further includes: The terminal device sends second indication information to the first network device.

The second indication information indicates that a network device to which the unavailable downlink time domain resource belongs is the second network device. The second indication information may include an identity of the second network device, for example, an ID of the second network device. The terminal device may determine, based on the ID that is of the second network device and that is carried in the second indication information, that the time domain resource indicated by the first indication information is the unavailable downlink time domain resource of the second network device, to avoid incorrect identification or misidentification.

It may be understood that the first indication information and the second indication information may be same information. In other words, the first indication information and the second indication information may be carried in same information. In this case, the first indication information may further include the identity of the second network device. Alternatively, the first indication information and the second indication information may be different information. In other words, the first indication information and the second indication information may be carried in different information. In this case, the first network device needs to determine, based on the first indication information and the second indication information, that the network device to which the unavailable downlink time domain resource belongs is the second network device.

A name of the second indication information is merely an example, and the third indication information may alternatively be indication information #2, information #b, or the like. This is not limited.

In a possible design solution, after the terminal device receives the first message from the second network device, the method may further include: The terminal device receives configuration information from the second network device; and the terminal device performs downlink communication with the second network device on the time domain resource indicated by the first time domain resource configuration.

The configuration information may indicate the terminal device to perform downlink communication with the second network device on the time domain resource indicated by the first time domain resource configuration. The configuration information may be carried in TDRA of the DCI. The TDRA may indicate the first time domain resource configuration in the at least one time domain resource configuration. A specific implementation process of this step is similar to that of Case 2. Reference may be made for understanding. Details are not described again.

Optionally, after the terminal device receives the first message from the second network device, the method may further include:

When downlink communication between the terminal device and the first network device does not meet a preset condition, the terminal device sends third indication information to the first network device.

The third indication information may indicate that downlink communication between the terminal device and the first network device does not meet the preset condition.

When the first network device is not interfered with by another network device, for example, the second network device, or when caused interference is small, the terminal device may report to the first network device that downlink communication of the first network device is not interfered with by the second network device, so that the second network device can subsequently restore communication on a previously unavailable downlink time domain resource, thereby reducing a waste of resources and improving resource utilization.

A name of the third indication information is merely an example, and the third indication information may alternatively be indication information #3, information #c, or the like. This is not limited.

Optionally, after the terminal device sends the third indication information to the first network device, the method further includes:
The terminal device receives a second message from the second network device; and the terminal device performs downlink communication with the second network device on a consecutive time domain resource configured for downlink communication.

The second message may indicate a consecutive time domain resource configured for downlink communication of the second network device, and the consecutive time domain resource configured for downlink communication of the second network device may be understood as a consecutive time domain resource pre-assigned to the terminal device when the second network device does not consider to cause interference to another network device or the second network device causes small interference. When downlink communication between the terminal device and the first network device does not meet the preset condition, the second network device may restore communication on the previously unavailable downlink time domain resource. This reduces a waste of resources and thereby improving resource utilization.

Optionally, the second message may be carried in at least one of the following: an RRC message, DCI, a MAC-CE, or a SIB1. In other words, the second network device may send the second message to the terminal device based on an RRC message, DCI, a MAC-CE, or a SIB1.

This is not limited.

A name of the second message is merely an example, and the second message may alternatively be a message #2, a message #b, or the like. This is not limited.

It may be understood that the unavailable downlink time domain resource of the second network device is described by using a dimension of a symbol in a slot as an example. A dimension of a time unit is not limited in this embodiment of this application. In other words, the unavailable downlink time domain resource of the second network device may alternatively be in a dimension like a slot, a subframe, or a radio frame. An implementation principle is the same as that of the symbol dimension. Reference may be made for understanding of a specific implementation. Details are not described again.

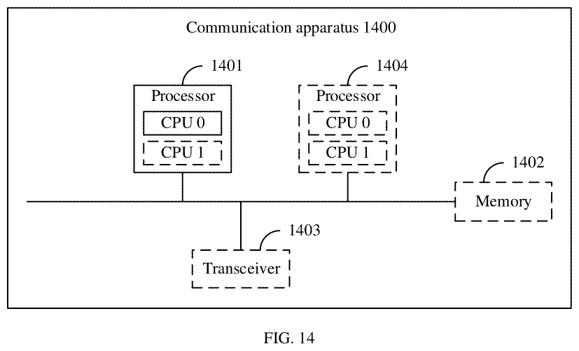

The foregoing describes in detail, with reference to FIG. 8 to FIG. 12, the communication method provided in embodiments of this application. The following describes in detail, with reference to FIG. 13 and FIG. 14, a communication apparatus configured to perform the communication method provided in embodiments of this application.

FIG. 13 is a first diagram of a structure of a communication apparatus according to an embodiment of this application. For example, as shown in FIG. 13, the communication apparatus 1300 includes a transceiver module 1301 and a processing module 1302. For ease of description, FIG. 13 shows only main components of the communication apparatus 1300.

In some embodiments, the communication apparatus 1300 is applicable to the communication system shown in FIG. 5, and performs a function of the terminal device.

The transceiver module 1301 may be configured to perform a function of the terminal device for receiving and sending a message, and the processing module 1302 may perform a function of the terminal device other than receiving and sending a message. For example, the processing module 1302 is configured to control the transceiver module to send first indication information to a first network device. The transceiver module 1301 is configured to receive a first message from a second network device. The first indication information is used for indicating an unavailable downlink time domain resource, and the unavailable downlink time domain resource is an unavailable downlink time domain resource of the second network device. The first message includes at least one downlink time domain resource configuration, a time domain resource indicated by the at least one downlink time domain resource configuration is a time domain resource available to downlink communication between the second network device and the communication apparatus according to the third aspect, the time domain resource indicated by the at least one downlink time domain resource configuration is a non-consecutive time domain resource, and the time domain resource indicated by the at least one time domain resource configuration does not include the unavailable downlink time domain resource.

Optionally, the transceiver module 1301 may include a sending module (not shown in FIG. 13) and a receiving module (not shown in FIG. 13). The sending module is configured to implement a sending function of the communication apparatus 1300, and the receiving module is configured to implement a receiving function of the communication apparatus 1300.

Optionally, the communication apparatus 1300 may further include a storage module (not shown in FIG. 13). The storage module stores a program or instructions. When the processing module 1302 executes the program or the instructions, the communication apparatus 1300 is caused to perform the communication method.

It should be noted that the communication apparatus 1300 may be a terminal device, may be a chip (system) or another part or component in the terminal device, or may be an apparatus including the terminal device. This is not limited in this embodiment of this application.

In addition, for technical effects of the communication apparatus 1300, refer to technical effects of the communication method shown in FIG. 8. Details are not described herein again.

In some embodiments, the communication apparatus 1300 is applicable to the communication system shown in FIG. 4, and performs a function of the second network device.

The transceiver module 1301 may be configured to perform a function of the second network device for receiving and sending a message, and the processing module 1302 may perform a function of the second network device other than receiving and sending a message. For example, the transceiver module 1301 is configured to receive indication information from a first network device. The processing module 1302 is configured to send a first message to a terminal device based on the indication information. The indication information indicates an unavailable downlink time domain resource, and the unavailable downlink time domain resource is an unavailable downlink time domain resource of the communication apparatus. The first message includes at least one downlink time domain resource configuration, a time domain resource indicated by the at least one downlink time domain resource configuration is a time domain resource available to downlink communication between the communication apparatus according to the fourth aspect and the terminal device, the time domain resource indicated by the at least one downlink time domain resource configuration is a non-consecutive time domain resource, and the time domain resource indicated by the at least one time domain resource configuration does not include the unavailable downlink time domain resource.

Optionally, the transceiver module 1301 may include a sending module and a receiving module. The sending module is configured to implement a sending function of the communication apparatus 1300, and the receiving module is configured to implement a receiving function of the communication apparatus 1300.

Optionally, the communication apparatus 1300 may further include a storage module. The storage module stores a program or instructions. When the processing module 1302 executes the program or the instructions, the communication apparatus 1300 is caused to perform the communication method.

It should be noted that the communication apparatus 1300 may be a network device, may be a chip (system) or another part or component in the network device, or may be an apparatus including the network device. This is not limited in this application.

In addition, for technical effects of the communication apparatus 1300, refer to technical effects of the communication method. Details are not described herein again.

For example, FIG. 14 is a second diagram of a structure of a communication apparatus according to an embodiment of this application. The communication apparatus may be a terminal, or may be a chip (system) or another part or component in the terminal. As shown in FIG. 14, the communication apparatus 1400 may include a processor 1401. Optionally, the communication apparatus 1400 may further include a memory 1402 and/or a transceiver 1403. The processor 1401 is coupled to the memory 1402 and the transceiver 1403. For example, the processor 1401 may be connected to the memory 1402 and the transceiver 1403 through a communication bus.

The parts of the communication apparatus 1400 are described below in detail with reference to FIG. 14.

The processor 1401 is a control center of the communication apparatus 1400, and may be one processor, or may be a general term of a plurality of processing elements. For example, the processor 1401 is one or more central processing units (central processing unit, CPU), may be an application-specific integrated circuit (application-specific integrated circuit, ASIC), or may be one or more integrated circuits configured to implement embodiments of this application, for example, one or more microprocessors (digital signal processor, DSP), or one or more field programmable gate arrays (field programmable gate array, FPGA).

Optionally, the processor 1401 may perform various functions of the communication apparatus 1400, for example, perform the communication method shown in FIG. 8 to FIG. 12, by running or executing a software program stored in the memory 1402 and invoking data stored in the memory 1402.

During specific implementation, in an embodiment, the processor 1401 may include one or more CPUs, for example, a CPU 0 and a CPU 1 in FIG. 14.

During specific implementation, in an embodiment, the communication apparatus 1400 may alternatively include a plurality of processors, for example, the processor 1401 and a processor 1404 shown in FIG. 14. Each of the processors may be a single-core processor (single-CPU), or may be a multi-core processor (multi-CPU). The processor herein may be one or more devices, circuits, and/or processing cores configured to process data (for example, computer program instructions).

The memory 1402 is configured to store the software program for performing the solutions in this application, and the processor 1401 controls execution of the software program. For a specific implementation, refer to the foregoing method embodiments. Details are not described herein again.

Optionally, the memory 1402 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer, but is not limited thereto. The memory 1402 may be integrated with the processor 1401, or may exist independently, and is coupled to the processor 1401 through an interface circuit (not shown in FIG. 14) of the communication apparatus 1400. This is not specifically limited in this embodiment of this application.

The transceiver 1403 is configured to communicate with another communication apparatus. For example, the communication apparatus 1400 is a terminal device, and the transceiver 1403 may be configured to communicate with a network device or communicate with another terminal device. For another example, the communication apparatus 1400 is a network device, and the transceiver 1403 may be configured to communicate with a terminal device or communicate with another network device.

Optionally, the transceiver 1403 may include a receiver and a transmitter (not separately shown in FIG. 14). The receiver is configured to implement a receiving function, and the transmitter is configured to implement a sending function.

Optionally, the transceiver 1403 may be integrated with the processor 1401, or may exist independently, and is coupled to the processor 1401 through an interface circuit (not shown in FIG. 14) of the communication apparatus 1400. This is not specifically limited in this embodiment of this application.

It should be noted that the structure of the communication apparatus 1400 shown in FIG. 14 does not constitute a limitation on the communication apparatus. An actual communication apparatus may include more or fewer components than those shown in the figure, combine some components, or have different component arrangements.

In addition, for technical effects of the communication apparatus 1400, refer to technical effects of the communication method in the foregoing method embodiments. Details are not described herein again.

An embodiment of this application provides a communication system. The communication system may include the terminal device, the first network device, and the second network device in the foregoing method embodiments.

It should be understood that, the processor in embodiments of this application may be a central processing unit (central processing unit, CPU), or the processor may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

It should be further understood that the memory in embodiments of this application may be a volatile memory or a non-volatile memory, or may include both a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through an example rather than a limitative description, random access memories (random access memory, RAM) in many forms may be used, for example, a static random access memory (static RAM, SRAM), a dynamic random access memory (dynamic random access memory, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or some of the foregoing embodiments may be implemented using software, hardware (for example, a circuit), firmware, or any combination thereof. When software is used to implement embodiments, the foregoing embodiments may be implemented completely or partially in a form of a computer program product. The computer program product includes one or more computer instructions or computer programs. When the computer instructions or the computer programs are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wireless (for example, infrared, radio, and microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: Only A exists, both A and B exist, and only B exists, where A and B may be singular or plural. In addition, the character “/” in this specification usually indicates an “or” relationship between the associated objects, or may indicate an “and/or” relationship. A specific meaning depends on the context.

In this application, “at least one” means one or more, and “a plurality of” means two or more. “At least one of the following items (pieces)” or a similar expression thereof means any combination of these items, including a singular item (piece) or any combination of plural items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a portable hard drive, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, wherein the method comprises:
sending, by a communication apparatus, first indication information to a first network device, wherein the first indication information indicates an unavailable downlink time domain resource, and the unavailable downlink time domain resource is an unavailable downlink time domain resource of a second network device; and
receiving, by the communication apparatus, a first message from the second network device, wherein the first message comprises at least one downlink time domain resource configuration, a time domain resource indicated by the at least one downlink time domain resource configuration is a time domain resource available to downlink communication between the second network device and the communication apparatus, the time domain resource indicated by the at least one downlink time domain resource configuration is a non-consecutive time domain resource, and the time domain resource indicated by the at least one time domain resource configuration does not comprise the unavailable downlink time domain resource.

2. The method according to claim 1, wherein the method further comprises:
sending, by the communication apparatus, second indication information to the first network device, wherein the second indication information indicates that a network device to which the unavailable downlink time domain resource belongs is the second network device.

3. The method according to claim 2, wherein the second indication information comprises an identity of the second network device.

4. The method according to claim 1, wherein sending, by the communication apparatus, the first indication information to the first network device comprises:
when downlink communication between the communication apparatus and the first network device meets a preset condition, sending, by the communication apparatus, the first indication information to the first network device, wherein the preset condition comprises at least one of the following:
a block error rate is greater than a first preset threshold;
a signal to interference plus noise ratio is greater than a second preset threshold; or
a communication rate is less than a third preset threshold.

5. The method according to claim 4, wherein after receiving, by the communication apparatus, the first message from the second network device, the method further comprises:
when downlink communication between the communication apparatus and the first network device does not meet the preset condition, sending, by the communication apparatus, the second indication information to the first network device, wherein the second indication information indicates that downlink communication between the communication apparatus and the first network device does not meet the preset condition.

6. The method according to claim 1, wherein the first message carries information indicating a consecutive time domain resource, and the information indicating a consecutive time domain resource further indicates the at least one downlink time domain resource configuration.

7. The method according to claim 1, wherein a first time domain resource configuration is one of the at least one time domain resource configuration, the first time domain resource configuration comprises a bitmap, and the bitmap is used to represent a time domain resource indicated by the first time domain resource configuration.

8. An apparatus, comprising:
at least one processor; and
one or more memories coupled to the at least one processor and storing programming instructions for execution by the at least one processor to:
send first indication information to a first network device, wherein the first indication information indicates an unavailable downlink time domain resource, and the unavailable downlink time domain resource is an unavailable downlink time domain resource of a second network device; and
receive a first message from the second network device, wherein the first message comprises at least one downlink time domain resource configuration, a time domain resource indicated by the at least one downlink time domain resource configuration is a time domain resource available to downlink communication between the second network device and the communication apparatus, the time domain resource indicated by the at least one downlink time domain resource configuration is a non-consecutive time domain resource, and the time domain resource indicated by the at least one time domain resource configuration does not comprise the unavailable downlink time domain resource.

9. The apparatus according to claim 8, wherein the one or more memories further storing programming instructions for execution by the at least one processor to:
send second indication information to the first network device, wherein the second indication information indicates that a network device to which the unavailable downlink time domain resource belongs is the second network device;
wherein the second indication information comprises an identity of the second network device.

10. The apparatus according to claim 8, wherein send the first indication information to the first network device comprises:
when downlink communication between the communication apparatus and the first network device meets a preset condition, send the first indication information to the first network device, wherein the preset condition comprises at least one of the following:
a block error rate is greater than a first preset threshold;
a signal to interference plus noise ratio is greater than a second preset threshold; or
a communication rate is less than a third preset threshold.

11. The apparatus according to claim 10, wherein the one or more memories further storing programming instructions for execution by the at least one processor to:
when downlink communication between the communication apparatus and the first network device does not meet the preset condition, send the second indication information to the first network device, wherein the second indication information indicates that downlink communication between the communication apparatus and the first network device does not meet the preset condition.

12. The apparatus according to claim 8, wherein the first message carries information indicating a consecutive time domain resource, and the information indicating a consecutive time domain resource further indicates the at least one downlink time domain resource configuration.

13. The apparatus according to claim 8, wherein a first time domain resource configuration is one of the at least one time domain resource configuration, the first time domain resource configuration comprises a bitmap, and the bitmap is used to represent a time domain resource indicated by the first time domain resource configuration.

14. An apparatus, comprising:
at least one processor; and
one or more memories coupled to the at least one processor and storing programming instructions for execution by the at least one processor to:
receive first indication information from a first network device, wherein the first indication information indicates an unavailable downlink time domain resource, and the unavailable downlink time domain resource is an unavailable downlink time domain resource of the second network device; and
send a first message to a communication apparatus based on the first indication information, wherein the first message comprises at least one downlink time domain resource configuration, a time domain resource indicated by the at least one downlink time domain resource configuration is a time domain resource available to downlink communication between the second network device and the communication apparatus, the time domain resource indicated by the at least one downlink time domain resource configuration is a non-consecutive time domain resource, and the time domain resource indicated by the at least one time domain resource configuration does not comprise the unavailable downlink time domain resource.

15. The apparatus according to claim 14, wherein a first time domain resource configuration is one of the at least one time domain resource configuration, and the first time domain resource configuration comprises first information and second information; the first information indicates a time domain resource configured for downlink communication between the communication apparatus and the second network device, and the second information indicates the unavailable downlink time domain resource; and the configured time domain resource comprises the unavailable downlink time domain resource.

16. The apparatus according to claim 15, wherein the first information is start symbol and symbol length information of the configured time domain resource, and the second information is start symbol and symbol length information of the unavailable time domain resource.

17. The apparatus according to claim 14, wherein a first time domain resource configuration is one of the at least one time domain resource configuration, the first time domain resource configuration comprises first information and second information, the first information indicates a first time domain resource, and the second information indicates a second time domain resource; and the first time domain resource comprises at least one consecutive time domain resource segment in a time domain resource indicated by the first time domain resource configuration, and the second time domain resource comprises a time domain resource other than the at least one consecutive time domain resource segment in the time domain resource indicated by the first time domain resource configuration.

18. The apparatus according to claim 17, wherein the first information is start symbol and symbol length information of the first time domain resource, and the second information is start symbol and symbol length information of the second time domain resource.

19. The apparatus according to claim 14, wherein the time domain resource indicated by the first time domain resource configuration comprises at least two consecutive time domain resource segments.

20. The apparatus according to claim 14, wherein the first message is carried in at least one of the following:
a radio resource control RRC message, a downlink control information DCI, a MAC-CE, or a system information block SIB1.
